(19) United States
(12) Patent Application Publication
(10) Pub. No.: US 2016/0171451 A1
(43) Pub. Date: Jun. 16, 2016

(54) SYSTEM AND METHOD FOR TRACKING EMPLOYEE ATTENDANCE AND MANAGING EMPLOYEE ACCESS TO COMPANY ASSETS

(71) Applicant: Meijer, Inc., Grand Rapids, MI (US)

(72) Inventors: Brian Pugh, Grand Rapids, MI (US); Elmer L. Robinson, JR., Marne, MI (US); David Scott Pallas, Hudsonville, MI (US); Michael Mullican, Grand Rapids, MI (US); K. Michael Ross, Grand Rapids, MI (US)

(21) Appl. No.: 14/965,767

(22) Filed: Dec. 10, 2015

Related U.S. Application Data
(60) Provisional application No. 62/090,355, filed on Dec. 10, 2014.

(51) Int. Cl. G06Q 10/10

(52) U.S. Cl. CPC G06Q 10/1093; G06Q 10/1091

(57) ABSTRACT

In a system and method for tracking employee time and attendance, device codes stored in a database are each associated with a corresponding identity of one of a plurality of enterprise facilities, employee codes stored in a database are each associated with a different employee of the business enterprise, and in response to wirelessly received information including a device code and an employee code, one of the plurality of device codes in the database is identified that matches the wirelessly received device code, the enterprise facility associated in the database with the matching device code is identified, the employee code that matches the wirelessly received employee code is determined, and in an employee attendance record identified with the matching employee code, the identified of facility, a calendar date and time of day at which the wirelessly received information was wirelessly received are logged.

### CROSS-REFERENCE TO RELATED APPLICATION

This patent application claims the benefit of, and priority to, U.S. Provisional Patent Application Ser. No. 62/090,355, filed Dec. 10, 2014, the disclosure of which is expressly incorporated herein by reference.

### FIELD OF THE INVENTION

The present invention relates generally to systems and methods via which employers can track employee attendance and time, and further to such systems and methods with which employers can manage employee access to company assets.

### BACKGROUND

Employers typically track time and attendance of employees for purposes of determining employee compensation and/or for monitoring employee behavior. Some conventional employee attendance tracking systems require employees to manually log arrival and departure times, and some further require employees to manually log other non-work related time period such as lunch times, dinner times, break times, off-site appointment times, and/or other such time periods.

### SUMMARY

The present invention may comprise one or more of the features recited in the attached claims, and/or one or more of the following features and combinations thereof. In one aspect, a method of tracking employee attendance at an employer's facility may comprise associating, with a processor in a first database, each of a plurality of device codes stored in the first database with a corresponding identity of one of a plurality of enterprise facilities, associating, with a processor in the first or a second database, each of a plurality of employee codes with a different one of a plurality of employees of the business enterprise, and in response to wirelessly received information including a device code and an employee code, determining with the processor the one of the plurality of device codes in the first database that matches the wirelessly received device code, identifying with the processor the one of one or more of the plurality of enterprise facilities associated in the first database with the matching device code, determining with the processor the one of the plurality of employee codes in the first or second database that matches the wirelessly received employee code, and logging in an employee attendance record in the first or the second database identified with the matching employee code the identified one of the plurality of facilities, a calendar date and time of day at which the wirelessly received information was wirelessly received.

### BRIEF DESCRIPTION OF THE DRAWINGS

This disclosure is illustrated by way of example and not by way of limitation in the accompanying figures. Where considered appropriate, reference labels have been repeated among the figures to indicate corresponding or analogous elements.

FIG. 1 is a simplified block diagram of an embodiment of a system for tracking employee attendance and managing employee access to company assets.

FIG. 2 is a simplified block diagram of an embodiment of one of the mobile communication devices illustrated in FIG. 1.

FIG. 3 is a simplified block diagram of an embodiment of an environment of the main server of FIG. 1.

FIG. 4A is a simplified diagram of an example implementation of the system of FIG. 1 in a business enterprise facility.

FIG. 4B is a simplified diagram of a communications framework for detecting by an employee mobile communication device of wireless signals broadcast by wireless signal broadcasting devices of the type illustrated in FIG. 4A, and for conducting wireless communications relating thereto between the employee mobile communication device and the main server of the business enterprise.

FIG. 5A is a simplified flow diagram of an embodiment of a process for monitoring employee work schedules, tracking employee attendance and managing employee access to company assets.

FIG. 5B is a simplified flow diagram of an embodiment of an employee entrance/exit monitoring process.

FIG. 5C is a simplified flow diagram of an embodiment of an employee tracking process.

FIG. 6A is a simplified flow diagram of an embodiment of an employee off-schedule process.

FIG. 6B is a simplified flow diagram of another embodiment of an employee off-schedule process.

FIG. 7A is a simplified flow diagram of an embodiment of a facility identification process.

FIG. 7B is a simplified flow diagram of another embodiment of a facility identification process.

FIG. 8 is a simplified flow diagram of an embodiment of the mobile communication device process illustrated in the flow diagram of FIG. 5B.

FIG. 9A is a simplified flow diagram of an embodiment of the mobile device process illustrated in the flow diagram of FIG. 5B.

FIG. 9B is a simplified flow diagram of an embodiment of a security process executed during the process illustrated in FIG. 9A.

FIG. 10 is a simplified flow diagram of an embodiment of a process implementing the security process of FIG. 9B

FIG. 11 is a simplified diagram of an interior portion of an employer facility.

### DETAILED DESCRIPTION OF THE DRAWINGS

While the concepts of the present disclosure are susceptible to various modifications and alternative forms, specific exemplary embodiments thereof have been shown by way of example in the drawings and will herein be described in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases may or may not necessarily refer to the same embodiment. Further, when a particular feature, structure, process, process step or characteristic is described in connection with an embodiment, it is submitted that it is within the knowledge of one skilled in the art to effect such feature, structure, process, process step or characteristic in connection with other embodiments whether or not explicitly described. Further still, it is contemplated that any single feature, structure, process, process step or characteristic disclosed herein may be combined with any one or more other disclosed feature, structure, process, process step or characteristic, whether or not explicitly described, and that no limitations on the types and/or number of such combinations should therefore be inferred.

Embodiments of the invention may be implemented in hardware, firmware, software, or any combination thereof. Embodiments of the invention implemented in a computer system may include one or more bus-based interconnects between components and/or one or more point-to-point interconnects between components. Embodiments of the invention may also be implemented as instructions stored on one or more machine-readable media, which may be read and executed by one or more processors. A machine-readable medium may be embodied as any device or physical structure for storing or transmitting information in a form readable by a machine (e.g., a computing device). For example, a machine-readable medium may be embodied as any one or combination of read only memory (ROM); random access memory (RAM); magnetic disk storage media; optical storage media; flash memory devices; and others.

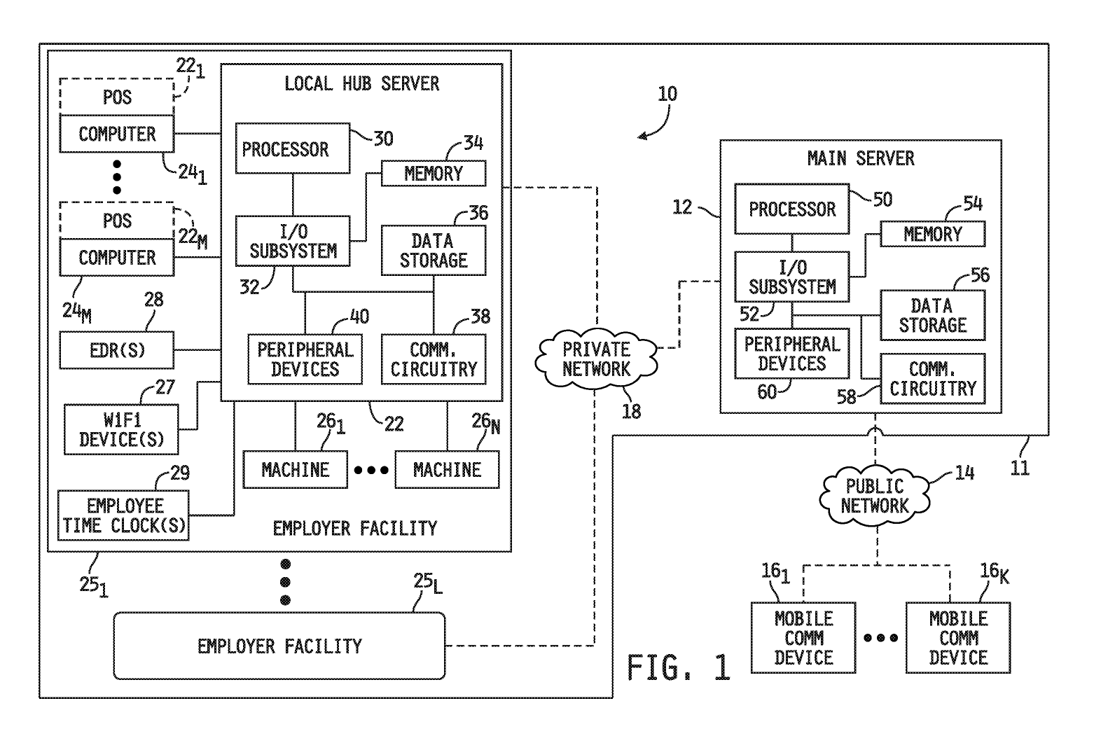

Referring now to FIG. 1, a system 10 is shown for tracking employee attendance and managing employee access to company assets. The system 10 includes a business enterprise 11 having a main server 12 configured to communicate with employees of the business enterprise via a public network 14, e.g., the Internet, and employees may access the public network 14 using any conventional public network accessible electronic device and/or system. In the illustrated embodiment, for example a number, J, of mobile communication devices 16₁-16ⱼ are shown, where J may be any positive integer. The business enterprise 11 may include any number of business facilities 25₁-25_{L} (employer facilities) each having one or more computers 24₁-24_{M} and/or machines 26₁-26_{N} operating therein and each including any number, of employee/device recognition (EDR) devices 28. The main server 12 is configured to communicate with each such computer 24₁-24_{M} and/or machine 26₁-26_{N}, each of which operate in a conventional manner.

Each of the facilities 25₁-25_{L} may further include at least one conventional WiFi Access Point 27 which may be coupled to the corresponding local hub server 22, or directly to the main server 12 in any one or more of the facilities 25₁-25_{L} not having an associated local hub server 22. Each such WiFi Access Point 27 is illustratively controlled by the main server 12 (or corresponding local hub server 22) in a conventional manner to establish at least one corresponding Internet hotspot within the facility 25 via which customers (and employees) can access the public network 14, e.g., to access the Internet, using any conventional public network accessible electronic device and/or system, e.g., such as with any of the plurality of mobile communication devices 16₁-16_{K}.

In the embodiment illustrated in FIG. 1, the main server 12 is illustratively coupled via a private network 20 to a plurality of local hub servers 22, each associated with a different one of a plurality of enterprise facilities 25₁-25_{L}, wherein L may be any positive integer. Some business enterprises may include a single enterprise facility, and other larger enterprises may include two or more physically remote facilities 25₁-25_{L}. In the latter case, the business enterprise may include, for example, a main physical location with two or more remote physical locations, and for purposes of this document the two or remote physical locations in such an arrangement may be referred to as “hub” locations. In this disclosure, the system 10 will be illustrated and described in the context of such a larger business enterprise having a main physical location and two or more physical hub locations. In this regard, the main server 12 in the system 10 shown in FIG. 1 will typically be located at a main business location of the business enterprise, and will be coupled via the network 20 to two or more local hub servers 22, each of which will typically be located at a different one of the two or more hub locations.

Each hub location may include any number of computers and/or machines coupled to a corresponding local hub server, and in the embodiment illustrated in FIG. 1, for example, the local hub server 22 is communicatively coupled to “M” such computers 24₁-24_{M}, where M may be any positive integer, and to “N” such machines 26₁-26_{N}, where N may be any positive integer. Communicative coupling between the local hub server 22 and the one or more computers 24₁-24_{M} and/or machines 26₁-26_{N} may be accomplished using any known communication coupling, and communications over any such hardwire and/or wireless coupling may be accomplished using any known communication protocol.

In some alternative embodiments of such a large business enterprise, one or more of the local hub servers 22 may be omitted, and the main server 12 may be coupled directly, via the network 20, to one or more computers 24₁-24_{M} and/or machines 26₁-26_{N}, or the main server 12 may be omitted and at least one of the local hub servers 22 may be configured to act as a so-called master server with the remaining local hub servers 22 configured to act as so-called slave servers. In other alternative embodiments in which the business enterprise 11 includes only a single facility 25, the local hub servers 22 may be or include the main server 12 or vice versa. For purposes of the following description, any process disclosed as being controlled by the main server 12 may, in some embodiments, instead be controlled, in whole or in part, by one or more local hub servers 22 and vice versa, and/or may be controlled, in whole or in part, by one of the computers 24₁-24_{M} and vice versa.

The local hub server 22 may be embodied as any type of server or similar computing device capable of performing the functions described herein. In the illustrative embodiment of FIG. 1, the local hub server 22 includes a processor 30, an I/O subsystem 32, a memory 34, a data storage 36, a communication circuitry 38, and one or more peripheral devices 40. It should be appreciated that the local hub server 22 may include other components, sub-components, and devices commonly found in a server and/or computing device, which are not illustrated in FIG. 1 for clarity of the description.

The processor 30 of the local hub server 22 may be embodied as any type of processor capable of executing software/firmware, such as a microprocessor, digital signal processor, microcontroller, or the like. The processor 30 may be a single processor or include multiple processors. The I/O subsystem 32 of the local hub server 22 may be embodied as circuitry and/or components to facilitate input/output operations with the processor 30 and/or other components of the local hub server 22. The processor 30 is communicatively coupled to the I/O subsystem 32.

The memory 34 of the user local hub server 104 may be embodied as or otherwise include one or more conventional volatile and/or non-volatile memory devices. The memory 34 is communicatively coupled to the I/O subsystem 32 via a number of signal paths. Although only a single memory device 34 is illustrated in FIG. 1, the local hub server 22 may include additional memory devices in other embodiments. Various data and software may be stored in the memory 34. The data storage 36 is also communicatively coupled to the I/O subsystem 32 via a number of signal paths, and may be embodied as any type of device or devices configured for the short-term or long-term storage of data such as, for example, memory devices and circuits, memory cards, hard disk drives, solid-state drives, or other data storage devices.

The communication circuitry 38 of the local hub server 22 may include any number of devices and circuitry for enabling communications between the local hub sever 22 and the main server 12 and between the local hub server 22 and the one or more computers 24₁-24_{M} and/or machines 26₁-26_{N}. In the illustrated embodiment, for example, communication between the local hub server 22 and the main server 12 takes place wirelessly via the network 20, wherein the network 20 may represent, for example, a private local area network (LAN), personal area network (PAN), storage area network (SAN), backbone network, global area network (GAN), wide area network (WAN), or collection of any such computer networks such as an intranet, extranet or the Internet (i.e., a global system of interconnected network upon which various applications or service run including, for example, the World Wide Web). In alternative embodiments, the communication path between the local hub server 22 and the main server 12 may be a non-private network and/or may be, in whole or in part, a wired connection. Generally, the communication circuitry 38 may be configured to use any one or more, or combination, of conventional secure and/or unsecure communication protocols to communicate with the main server 12. As such, the network 20 may include any number of additional devices, such as additional computers, routers, and switches, to facilitate communications between the local hub server 22 and the main server 12. Communication between the local hub server 22 and the one or more computers 24₁-24_{M} and/or machines 26₁-26_{N} may take place via one or more such wireless communication interfaces and/or via one or more conventional wired interfaces.

In some embodiments, the local hub server 22 may also include one or more peripheral devices 40. Such peripheral devices 40 may include any number of additional input/output devices, interface devices, and/or other peripheral devices. For example, the peripheral devices 40 may include a display, a keyboard, a mouse, audio processing circuitry, and/or other input/output devices.

Other local hub servers, e.g., serving other facilities 25₁-25_{L}, may be substantially similar to the local hub server 22 and include similar components. As such, the description provided above of the components of the local hub server 22 may be equally applicable to such similar components of other local hub servers and are not repeated herein so as not to obscure the present disclosure. Of course, it should be appreciated that in some embodiments one or more of the local hub servers 22 and may be dissimilar to others of the local hub servers 22.

An embodiment of the main server 12 is also illustrated in FIG. 1, and generally includes the same components as the local hub server 22. For example, a processor 50 is coupled to an I/O subsystem 52, and the I/O subsystem 52 is coupled to a memory 54, a data storage unit 56, communication circuitry 58 and one or more peripheral devices 60. In some embodiments, each of the foregoing components may be identical to corresponding components of the local hub server 22 described above, and a detailed explanation of such components will not be repeated here for brevity. In other embodiments, the main server 12 may be configured differently than the local hub server 22 described above. In any case, the communication circuitry 38 of each of the local hub servers 22 facilitates communication with the communication circuitry 58 of the main server 12 and vice versa so that information can be shared between the main server 12 and each of the one or more local hub servers 22 via the network 20. Although only one such main server 12 is shown in FIG. 1, it should be appreciated that, in other embodiments, the system 10 may include any number of shopper main servers, and in still other embodiments the main server 12 may be communicatively coupled to one or more remote servers of the business enterprise. Any such one or more remote servers may include any structure or feature illustrated and described herein with respect to the main server 12, and may be configured to execute any one or more functions described with respect to the main server 12 either alternatively to the main server 12 or in addition to the main server 12. In any case, the main server 12 may be embodied as any type of server (e.g., a web server) or similar computing device capable of performing the functions described herein.

The mobile communication devices 161-16J illustrated in FIG. 1 are intended to depict mobile communication devices that are each separately carried by a different employee. No limit on the total number of such mobile communication devices 161-16J that may be carried by any one employee, or on the total number of such mobile communication devices 161-16J that may communicate with the main server 12, is intended or should be inferred. The mobile communication devices 161-16J may be or include any mobile electronic device capable of executing one or more software application programs as described herein and of communicating with the main server 12 via the public network 14. Examples of the mobile communication devices 161-16J include, but should not be limited to, mobile telephones, smart phones, tablet computers, personal data assistants (PDAs), and the like.

Also depicted in FIG. 1 are any number of conventional employee/device recognition (EDR) devices 28 each illustratively coupled to the local hub server 22 in a different one of the facilities 251-25L such that each facility 25 includes one or more such EDRs 28. In alternate embodiments, one or more or all of the EDRs 28 may not be coupled to the local hub server 22. In one embodiment, one or more of the EDRs 28 is provided in the form of a wireless signal broadcasting devices 28, and in some such embodiments may be provided in the form of one or more conventional electronic beacons, e.g., conventional radio signal beacons, for the purpose of broadcasting radio signals carrying information corresponding to the location and/or identity thereof. Such wireless signal broadcasting devices 28 will, for purposes of this disclosure, be described as being implemented in the form of such beacons, although it will be understood that one or more of the wireless signal broadcasting devices 28 may alternatively take the form of one or more other conventional wireless signal broadcasting devices operable to broadcast wireless signals carrying information corresponding to the location and/or identity of thereof. For example, in an alternate embodiments one or more of the EDRs may be or include other electronic devices configured and operable to broadcast or otherwise emit, transmit and/or communicate via wireless identification signals detectable by any of the mobile communication devices illustrated and described herein. Examples of such other electronic devices may include, but are not limited to, transponders, radio-frequency identification (RFID) devices, near-field communication (NFC) devices, far-field communication devices, telemetry devices, automated identification and data capture (AIDC) devices, and the like.

In embodiments in which one or more of the EDRs is/are implemented in the form of one or more beacons, such beacons 28 in each of the facilities 251-25L are illustratively positioned at or near employee entrances and/or exits, although it will be understood that this disclosure contemplates other embodiments in which such beacons 28 and/or other EDRs are positioned at other various locations in and/or relative to one or more of the facilities 251-25L for the purpose of monitoring entrance to and/or exit from one or more of the facilities 251-25L, and/or entrance to and/or exit from one or more locations within one or more of the facilities 251-25L. Each such beacon 28 is, in any case, configured to periodically broadcast one or more unique wireless identification signals, i.e., one or more identification signals that distinguish the particular beacon 28 from other beacons 28.

In some embodiments, the beacons 28 are each configured to periodically broadcast wireless identification signals in the radio frequency (RF) range, although any of the one or more beacons 28 may be configured to alternatively broadcast wireless identification signals in one or more other frequency ranges. In any case, the beacons 28 are further each illustratively configured to broadcast wireless identification signals with a predefined broadcast range and/or orientation (i.e., direction).

Illustratively, the unique wireless identification signals broadcast by each beacon 28 carry decodable information in the form of a unique identification code (UID). Generally, the UID of each beacon 28 uniquely identifies that beacon and distinguishes that beacon from all other beacons within the business enterprise 11 or at least those located in any one facility 25. Those skilled in the art will recognize additional and/or alternative information that may be included within or appended to the UID, and/or carried by the unique wireless identification signals broadcast by the beacons 28, and it will be understood that any such additional and/or alternative information is contemplated by this disclosure.

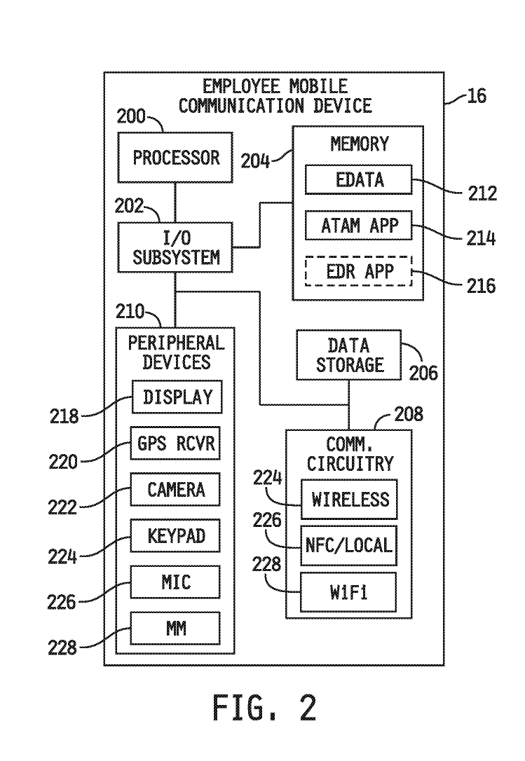

Referring now to FIG. 2, an embodiment of one of the mobile communication devices 16 illustrated in FIG. 1 is shown which illustratively includes components similar to the main server 12 and also to the one or more local hub servers 22 such as a processor 200, an I/O subsystem 202, a memory 204, a data storage device 206, communication circuitry 208 and a number of peripheral devices 210. In some embodiments, each of the foregoing components may be identical to corresponding components of the local hub server 22 described above, and a detailed explanation of such components will not be repeated here for brevity. In other embodiments, any of the one or more mobile communication devices 161-16J may be configured differently than the local hub server 22 described above. It will be appreciated that the mobile communication device 16 may include other components, sub-components, and devices commonly found in a computer and/or computing device.

The memory 204 illustratively includes an EDATA module 212 which illustratively has stored therein identification information of the employee that carries the mobile communication device 16. Illustratively, the employee identification information may be or include an employee identification code, EID, and/or communication information relating to a code or other identifier for communicating with the mobile communication device 16. The memory 204 further illustratively includes an attendance, time and asset management (ATAM) application 214 stored therein in the form of, e.g., instructions executable by the processor 200, to perform some of the functions described herein. In some embodiments, the memory 216 further illustratively has stored therein an EDR application 216, e.g., in the form of instruction executable by the processor 200, to control, enable and/or facilitate data exchange, extraction, reception and/or transmission with one or more of the alternate embodiments of one or more of the EDRs described above and/or described hereinafter.

The communication circuitry 208 illustratively includes conventional wireless communication circuitry 224. In some embodiments, the wireless communication circuitry 224 is configured to conduct and facilitate cellular telephone communications with other cellular and land-based communication devices. In some embodiments, the wireless communication circuitry 224 is configured to conduct and facilitate communication with the main server 12 via the network 14. In some embodiments, the wireless communication circuitry 224 and/or the WiFi module 228 is configured to access the network 14 via at least one hotspot established in any of the facilities 25 by a corresponding at least one WiFi Access Point 27.

In addition to, or alternatively to, the number of peripheral devices 40 of the local hub server 22 described above, the number of peripheral devices 210 of the mobile communication device 16 may include any number of other or additional peripheral or interface devices. Examples of such additional peripheral devices illustrated in FIG. 2 include, but should not be limited to, a conventional visual display unit or screen 218, a conventional global positioning system (GPS) receiver 220, a conventional camera 222, a conventional keypad 224, a conventional microphone 226 and a conventional magnetometer 228. The display 218 is configured, in a conventional manner, to be responsive to instructions produced by the processor 200 to display information thereon. The GPS receiver 220 is configured, in a conventional manner, to receive radio-frequency signals transmitted by earth-orbiting satellites and to produce corresponding signals from which geographical coordinates of the receiver 220 are or can be determined. The camera 222 is configured, in a conventional manner, to capture images and/or video and to display the same on the display 218. The keypad 224 is configured, in a conventional manner, to provide signals corresponding to manual selection and activation thereof to the processor 200, and the microphone 226 is configured, in a conventional manner, to capture sound waves and to provide signals corresponding thereto to the processor 200. The magnetometer 228 is configured, in a conventional manner, to detect local geomagnetic fields, to produce magnetic signature signals based thereon and to provide such signals to the processor 200.

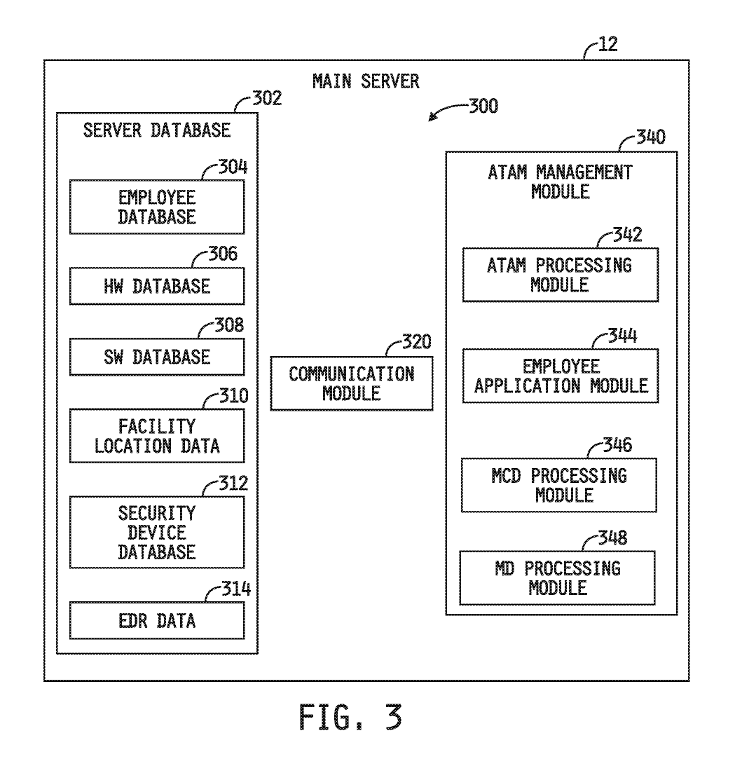

Referring now to FIG. 3, a simplified block diagram is shown of an embodiment of an environment 300 of the main server 12 illustrated in FIG. 1. In the embodiment shown in FIG. 3, the environment 300 includes a server database 302 which illustratively includes an employee database 304, a hardware database 306 a software database 308, a facility location database 308, a security device database 312 and an EDR database 314. The employee database 304 illustratively has stored therein identification information for each employee of the business enterprise 11. Additional information may be linked to such employee data for one or more of the employees, and examples of such linked data may include, but is not limited to, employee position, identification of one or more mobile communication devices 16 assigned to or otherwise carried by the employee, home address, and the like.

The hardware database 306 illustratively includes an identification of hardware components, e.g., computers 241-24M, machines 261-26N, mobile communication devices 161-16K, and other hardware devices. The hardware database 306 may further illustratively include information linked to or associated with any such hardware, examples of which include, but are not limited to, identification of one or more software programs contained therein, identification of one or more employees to which the device is assigned or used by, and the like.

The software database 308 illustratively includes an identification of software programs owned or licensed by the business enterprise. The software database 308 may further illustratively include information linked to or associated with any such software programs, examples of which include, but are not limited to, identification of computers 241-24M and/or machines 261-26N and/or mobile communication devices 161-16K in which such software programs are installed, identification of one or more employees authorized or assigned to used such software programs, and the like. The software database 308 may further illustratively include one or more lists of approved and/or disapproved software for use on any one or more of the computers 241-24M, machines 261-26N and/or mobile communication devices 161-16K.

The facility location database 310 illustratively has stored therein information relating to the identities and locations of the one or more enterprise facilities 251-25L.

The security device database 312 illustratively has stored therein identities and/or other information relating to one or more electronic security devices that may be integrated in, embedded in or attached to mobile devices and/or mobile apparatuses that may be transported by one or more employees to and/or from one or more of the facilities 251-25L.

The EDR data 314 illustratively has stored therein EDR identity information for each EDR 28 in the retail enterprise 11 as well as additional information from which the processor 50 can determine, for each device 28, the identity of the facility 25 at which each such device is located as well as the location or position within that location at which the EDR is located. In some embodiments, the EDR location data 314 may illustratively contain information about each device 28 in the retail enterprise 11 including, for example, unique identification codes (UID) of each EDR provided in the form of a wireless signal broadcasting device. In some embodiments, the EDR location data 314 may include additional information including, for example, but not limited to, positional information corresponding to the coordinates of some or all of the EDRs which are embodied as wireless signal broadcasting devices of the retail enterprise 11 and/or of one or more facility locations thereof, relative to one or more sets of base coordinates.

The environment 300 of the main server 12 further illustratively includes a communication module 320. The communication module 320 is configured, in a conventional manner, to control and manage all communications between the main server 12 and the local hub servers 22 in embodiments that include the local hub servers 22, and to control and manage all communications between the main server 12 and all computers 241-24M and/or machines 261-26N in embodiments that do not include a local hub server 22. The communication module 326 is further configured, in a conventional manner, to control and manage all wireless communications conducted between the main server 12 and the mobile communication devices 161-16J.

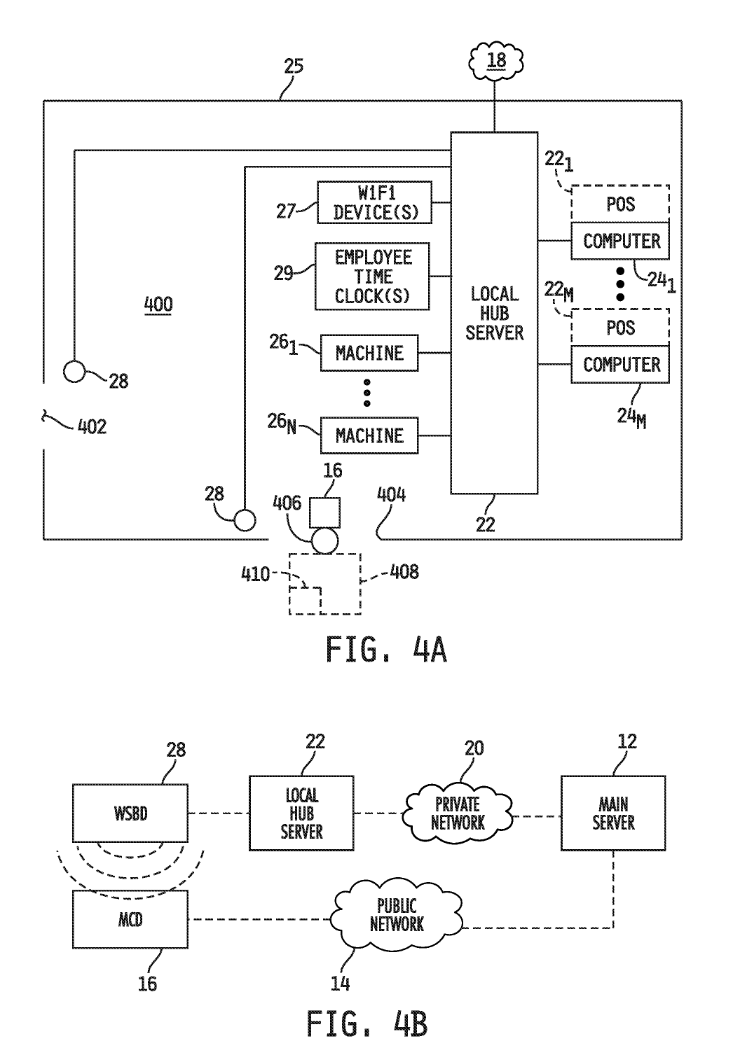

The environment 300 of the main server 12 further illustratively includes an ATAM management module 340 which illustratively includes an ATAM processing module 342, an employee application module 344, e.g., via which employees may obtain one or more applications to store on employee mobile communication devices 161-16K as illustrated and described with respect to FIG. 2, a mobile communication device processing module 346 and a mobile device processing module 348. The modules 342, 346 and 348 each illustratively have instructions stored therein which are executable by the processor 50 of the main server 12 to perform functions of the type described below with respect to FIGS. 4-8.

### Employee Work Schedule Monitoring Process

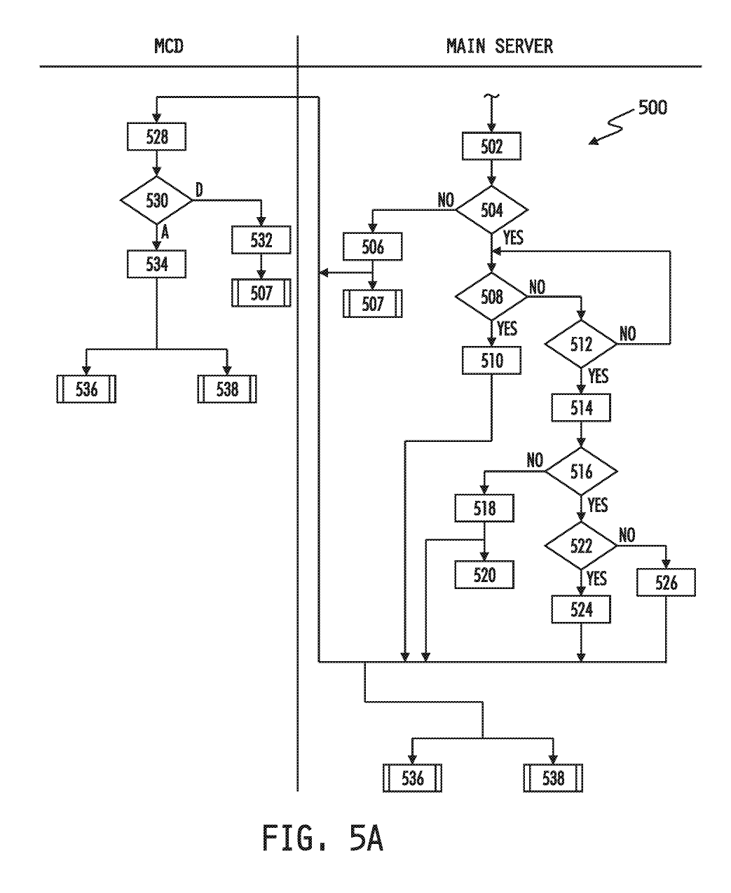

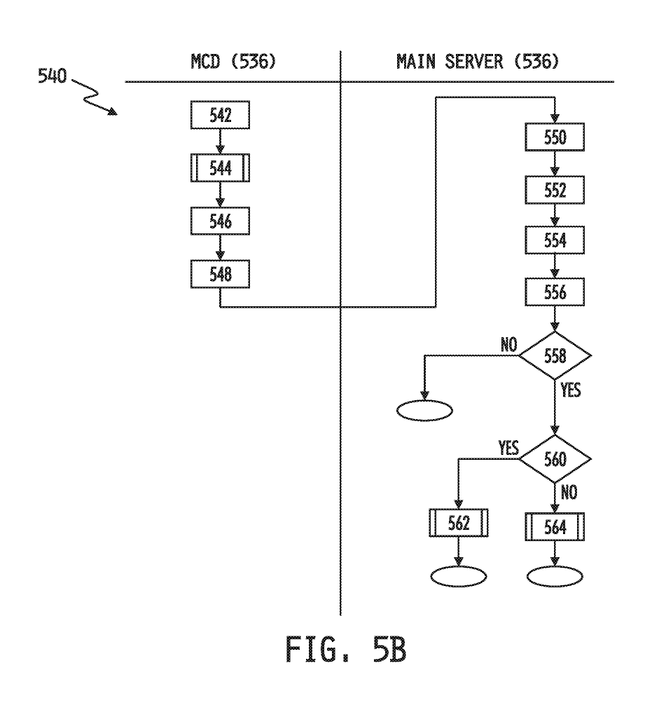

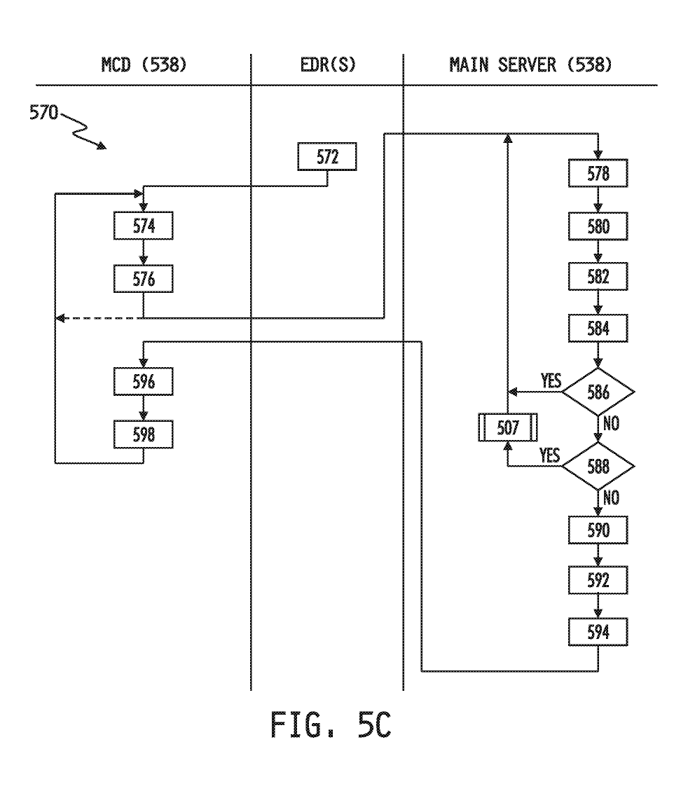

Referring now to FIG. 5A, a simplified flow diagram is shown of an embodiment of a process 500 for monitoring and tracking employee work schedules. As indicated by the framework of the process 500 illustrated in FIG. 5A, a portion of the process 500, i.e., the portion to the left of central vertical line and centered under the heading “MCD,” illustratively represents one or more applications executed by the processor 200 of an employee's mobile communication device 16, i.e., one of the mobile communication devices 161-16J associated with an employee of the business enterprise 11. In one embodiment, this portion of the process 500 is or includes the attendance, time and asset management (ATAM) application module 214 stored in the memory 204 (and/or data storage 206) of the employee's mobile communication device 16 (see FIG. 2) in the form of instructions executable by the processor 200 of the employee's mobile communication device 16. The process steps of this portion of the process 500 will be described below for purposes of this disclosure as being executed by the processor 200 of the employee's mobile communication device 16.

Another portion of the process 500, i.e., the portion to the right of the central vertical line in FIG. 5A, and centered under the heading “Main Server,” illustratively represents one or more applications executed by the processor 50 of the main server 12. In one embodiment, this portion of the process 500 is stored in the Attendance, time and asset management (ATAM) processing module 342 (see FIG. 3) in the form of instructions executable by the processor 50 of the main server 12. The process steps of this portion of the process 500 will be described below for purposes of this disclosure as being executed by the processor 50 of the main server 12. In some alternate embodiments, e.g., that may or may not include a main server 12, this portion of the process 500 may alternatively be stored in the memory 34 (and/or data storage 36) of one or more of the local hub servers 22 in the form of instructions executable by the processor 30 of the one or more local servers 22 and/or stored in a memory and executable by a processor of another system external to or supplemental to the system 10 illustrated FIG. 1. It will further be understood that portions of the process 500 illustrated as being executed by one processor/device or one processor/server or one processor/system may alternatively be executed by a different processor/device or processor/server or processor/system in the system 10, and/or by two or more such processors in any one or combination of such devices, servers and/or systems, some examples of which are described above.

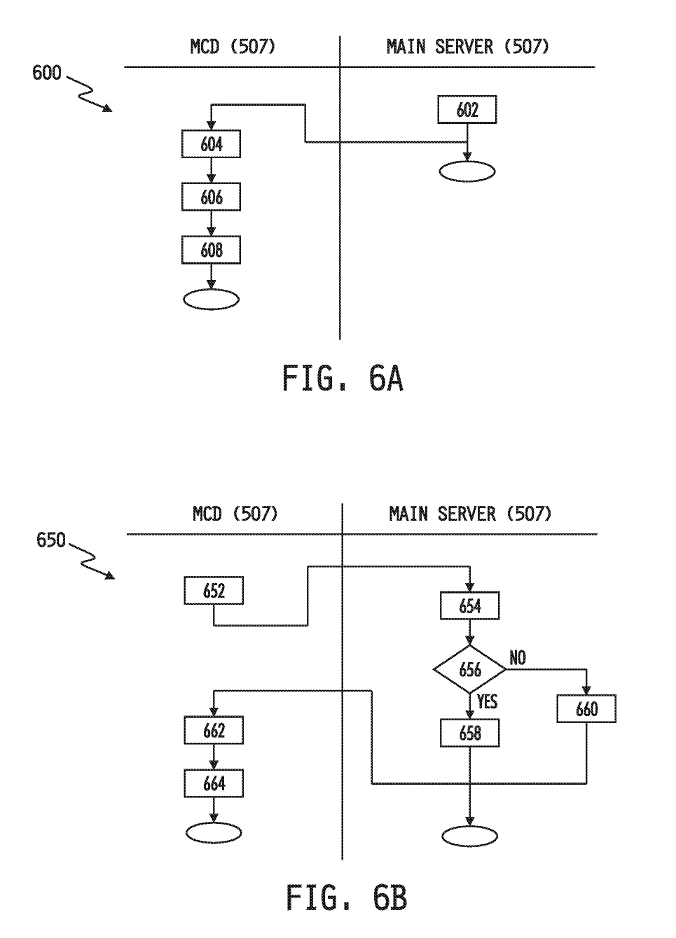

In one embodiment, the process 500 is illustratively executed by the processor 50 periodically for each employee of the retail enterprise 11. In other embodiments, the processor 50 is operable to execute the process 500 periodically for one or more subsets of such employees. In any case, the process 500 begins at step 502 where the processor 50 is operable to access an employee's work schedule stored in the employee database 304. Thereafter at step 504, the processor 50 is operable to determine whether the employee is scheduled to be working presently or within a near time frame. If not, the process 500 advances to step 506 where the processor 50 is operable to control the communication circuitry 58 to wirelessly transmit a “deactivation” signal to the identified employee's mobile communication device 16. Following step 506, the processor 50 is operable at step 507 to execute an employee off-schedule process. Example embodiments of the employee off-schedule process are illustrated in FIGS. 6A and 6B and will be described in detail hereinafter.

If, at step 504, the processor 50 determines that the identified employee is scheduled to be working presently or within a near time frame, the process 500 advances to step 508 where the processor 50 is operable to determine whether the employee is “clocked in,” i.e., whether the employee has notified the server 12, e.g., via a conventional employee time clock 29 or other device which communicates with the server 12, that the employee is reporting to work. If so, the process 500 advances to step 510 where the processor 50 is operable to control the communication circuitry 58 to wirelessly transmit a “wake up” signal to the identified employee's mobile communication device 16. If not, the process 500 advances to step 512 where the processor 50 is operable to compare the current time of day with the scheduled start time of the employee's work schedule. If the processor 50 determines at step 512 that the current time of day is earlier than the employee's scheduled start time, the process 500 loops back to step 508. Otherwise, the process 500 advances to step 514 where the processor 50 is operable to determine a current location of the identified employee.

At step 514, the identified employee may or may not have activated the employees ATAM application 214, and the processor 50 is illustratively operable to execute step 514 using one or more techniques for determining the employee's present location that do not involve use of the capabilities of the mobile ATAM application executable by the employees mobile communication device. In some embodiments, for example, the processor 50 is operable to execute step 514 by determining a location of the identified employee's mobile communication device 16 via a location-based service, last known GPS coordinates, Wifi hotspot use detection or the like. Other techniques for determining or estimating the present location of the identified employee that do not involve use of the mobile ATAM application will occur to those skilled in the art, and it will be understood that any such techniques are contemplated by this disclosure.

Following step 514, the process 500 advances to step 516 where the processor is operable to determine, based on the determined or estimated present location of the employee, whether the employee is presently located at the employer's facility 25 where the employee is scheduled to be working. If not, the processor 50 is operable at step 518 to control the communication circuitry 58 to wirelessly transmit to the employee's mobile communication device 16 one or more notifications or messages informing the employee that the employee is scheduled to be working. Thereafter at step 520, the processor 50 is operable to control the communication circuitry 58 to wirelessly transmit to the mobile communication device 16 of the employee's supervisor (and/or to email and/or text the employee's supervisor) one or more notifications or messages informing that the employee has not reported for work. In some embodiments, at least one notification message may further include the employee's contact information, e.g., mobile telephone, home telephone number, email address, etc.

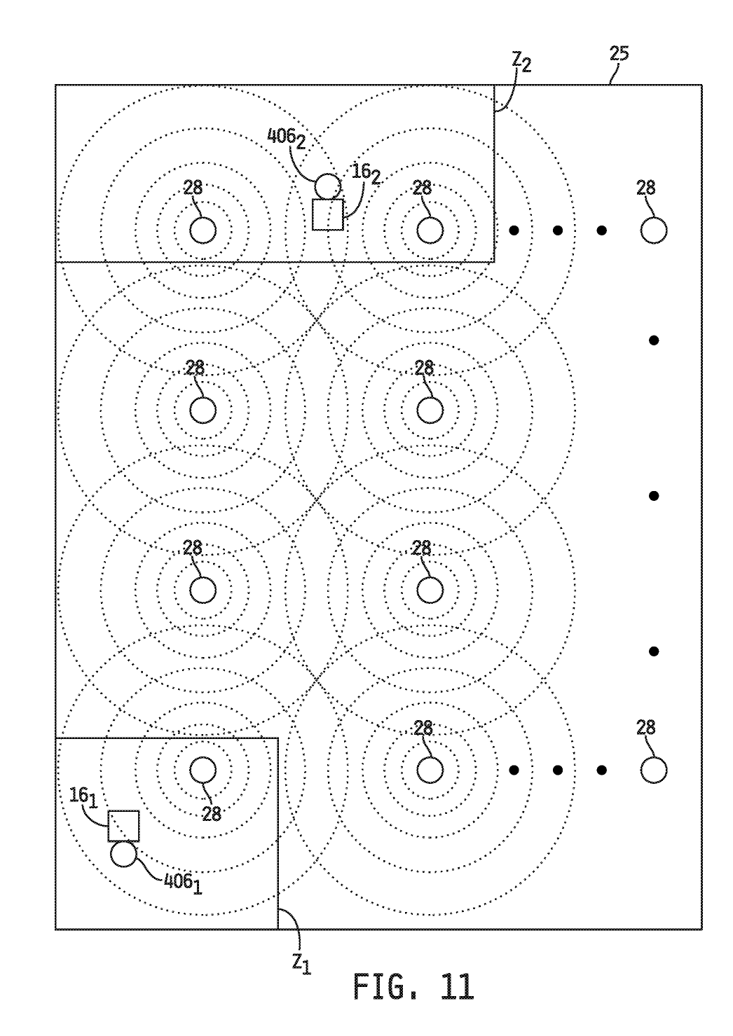

If, at step 516, the processor 50 determines that the identified employee is presently located in the employer's facility in which the employee is scheduled to be working, the process 500 advances to step 522 where the processor 50 is operable to determine whether the employee is presently location at or within a specified work zone in which the employee is physically located when working. Referring to FIG. 11, for example, an area within an employer's facility 25 is shown which includes two employee work zones Z1 and Z2, and in which a first employee 4061 is located within the first work zone Z1 and a second employee 4062 is located within the second work zone Z2. In some embodiments, the processor 50 is illustratively operable to determine the employee's present location using one or more of the techniques describe with respect to step 514. In other embodiments in which the identified employee's mobile communication device 16 is presently executing the ATAM application 214, the employee's present position may be more precisely determined using one or more of the EDRs 28 as described herein and/or using one or more alternate devices, systems and techniques thereto as also described herein. In any case, if the processor 50 determines at step 522 that the identified employee is presently located in the specified work zone in which the employee is physically located when working, the process 500 advances to step 524 where the processor 50 is operable to control the communication circuitry 58 to wirelessly transmit one or more messages or notifications to the employee's mobile communication device 16 and/or to the mobile communication device 16 of the employee's supervisor (or email address, text communication, etc. to either) informing that the employee, although working in or at the employee's designated work zone, did not clock in and should do so. If, at step 522, the processor 50 determines that the identified employee is presently not located in the specified work zone in which the employee is physically located when working, the process 500 advances to step 526 where the processor 50 is operable to control the communication circuitry 58 to wirelessly transmit one or more messages or notifications to the employee's mobile communication device 16 and/or to the mobile communication device 16 of the employee's supervisor (or email address, text communication, etc. to either) informing that the employee that the employee is scheduled to be working but is neither clocked in nor located in or at the employee's designated work zone.

At step 528, the employee's mobile communication device 16 wirelessly receives the one or more messages or notifications transmitted by the main server 12 at any of steps 506, 510, 518, 524 and 526. Following step 528, the processor 200 of the identified employee's mobile communication device 16 is operable to determine whether the message contains a deactivation signal or an activation signal, e.g., a wake up signal. If the former, the processor 200 is illustratively operable at step 532 to deactivate the ATAM application and to thereafter execute the employee off-schedule process. In embodiments in which the employee off-schedule process is part of the ATAM application, step 532 may be omitted or modified such that the processor 200 deactivates only by the employee off-schedule portion of the application.

If, at step 530, the processor 200 determines that the one or more messages or notifications wirelessly received at step 528 includes an activation signal, the processor 300 is operable to wake up and activate, i.e., launch, execution of the ATAM application 214. If the one or more messages also contains one or more textual or other such message intended to be reviewed by the employee, the processor 50 is operable to control the display 218 to display the message(s).

Following step 534 and steps 506, 510, 518, 524 and 526, the processor 200 of the employee's mobile communication device 16 and the processor 50 of the server 12 are both operable to execute an employee entrance/exit monitoring process at step 536 and an employee tracking process at step 538. An example embodiment of the employee entrance/exit monitoring process is illustrated in FIG. 5B and will be described in detail hereinafter, and an example embodiment of the employee tracking process is illustrated in FIG. 5C and will also be described in detail hereinafter.

### Employee Entrance/Exit Monitoring Process

Referring now to FIG. 5B, a simplified flow diagram is shown of an embodiment of a process 540 for monitoring employee entrance into and exit from an employer facility while the employee is working, i.e., scheduled to be working and presently clocked in as working. As indicated by the framework of the process 540 illustrated in FIG. 5B, a portion of the process 540, i.e., the portion to the left of central vertical line and centered under the heading “MCD,” illustratively represents one or more software applications executed by the processor 200 of an employee's mobile communication device 16, i.e., one of the mobile communication devices 161-16J associated with an employee of the business enterprise 11. In one embodiment, this portion of the process 540 is or includes the attendance, time and asset management (ATAM) application module 214 stored in the memory 204 (and/or data storage 206) of the employee's mobile communication device 16 (see FIG. 2) in the form of instructions executable by the processor 200 of the employee's mobile communication device 16. The process steps of this portion of the process 550 will be described below for purposes of this disclosure as being executed by the processor 200 of the employee's mobile communication device 16.

Another portion of the process 540, i.e., the portion to the right of the central vertical line in FIG. 5B, and centered under the heading “Main Server,” illustratively represents one or more software applications executed by the processor 50 of the main server 12. In one embodiment, this portion of the process 540 is stored in the Attendance, time and asset management (ATAM) processing module 342 (see FIG. 3) in the form of instructions executable by the processor 50 of the main server 12. The process steps of this portion of the process 540 will be described below for purposes of this disclosure as being executed by the processor 50 of the main server 12. In some alternate embodiments, e.g., that may or may not include a main server 12, this portion of the process 540 may alternatively be stored in the memory 34 (and/or data storage 36) of one or more of the local hub servers 22 in the form of instructions executable by the processor 30 of the one or more local servers 22 and/or stored in a memory and executable by a processor of another system external to or supplemental to the system 10 illustrated FIG. 1. It will further be understood that portions of the process 540 illustrated as being executed by one processor/device or one processor/server or one processor/system may alternatively be executed by a different processor/device or processor/server or processor/system in the system 10, and/or by two or more such processors in any one or combination of such devices, servers and/or systems, some examples of which are described above.

In the process 540 illustrated in FIG. 5B, item 542 of the process 540 does not necessarily represent a part of the process 540 executed by an employee's mobile communication device 16, but rather represents an employee entering or exiting an employee entrance/exit to/from one of the business enterprise facilities 251-25L. This scenario is illustrated by example in FIG. 4A which depicts one of the business enterprise facilities 25 in which the outermost perimeter illustratively represents one or more exterior walls of the facility 25 enclosing an interior space 400 of the facility 25. Two employee entrances/exits 402 and 404 are shown, and both entrances/exits 402, 404 in the example illustratively operate both as an employee entrance to the facility 25, i.e., a passageway via which employees may enter the facility 25, and an employee exit of the facility, i.e., a passageway via which employees may exit the facility 25. In some alternate embodiments, the facility may be equipped with one or more employee entrances and one or more employee exits separate from the one or more employee entrances. Moreover, although the employee entrances/exits 402 and 404 are illustrated in FIG. 4A in the form of entrances/exits to/from the interior space 400 of the facility relative to an area external to the facility 25, it will be understood that either or both of the employee entrances/exits 402, 404 may alternatively represent entrances/exits to/from the interior space 400 of the facility 25 relative to another interior space of the facility 400 or relative to another adjoining or conjoined one of the employer facilities 251-25L of the business enterprise 11.

As illustrated in FIG. 4A, the facility 400 illustratively includes some or all of the items illustrated in FIG. 1, although other embodiments the facility 400 may include more, fewer and/or different components. In any case, an employee 406 is depicted in FIG. 4A as entering (or exiting) the facility 25 via the employee entrance/exit 404, and the employee 406 is illustratively carrying the employee's mobile communication device 16 as the employee 406 passes through the entrance/exit 404. In some embodiments, the ATAM application 214 is activated and executing as the employee 406 enters/exits the facility 25.

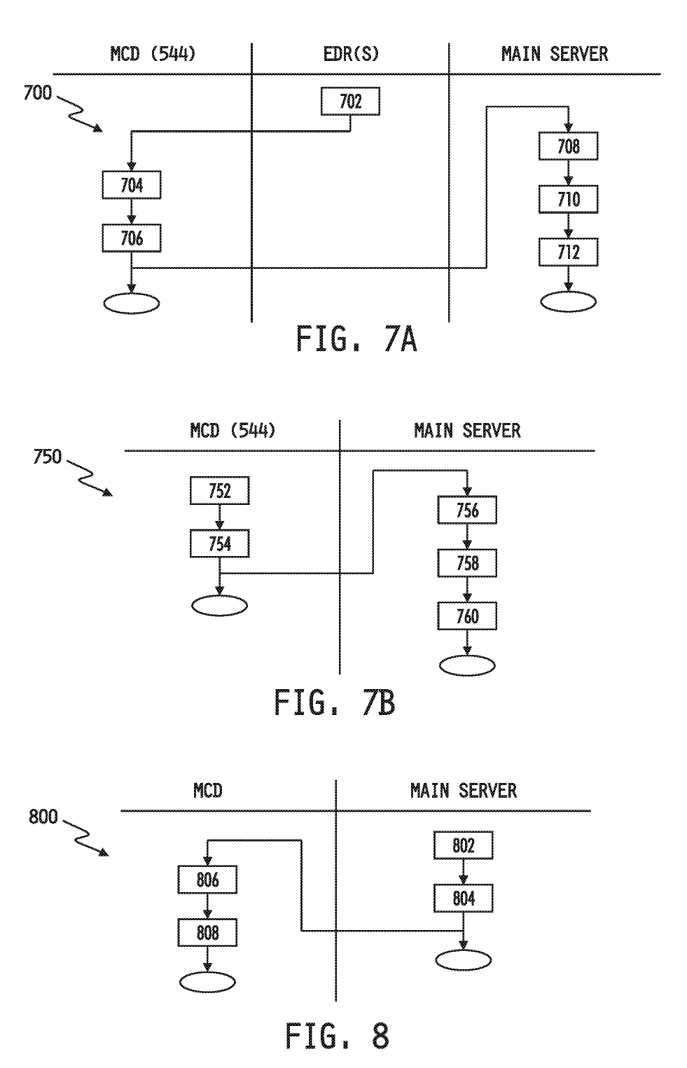

Upon entrance/exit of the employee to/from one of the facilities 251-25L, as depicted at step 542, the process 540 illustratively begins at step 544 where the employee is automatically identified and the one of the facilities 251-25L that the employee is entering or exiting is also identified. In some embodiments, the entrance/exit used by the identified employee to enter/exit the identified facility is also identified. Various different techniques are contemplated for determining the identity of the facility 251-25L at step 544, and some such techniques are described in detail below with reference to FIGS. 7A and 7B.

The process 540 advances from step 544 to step 546 where the processor 200 of the employee's mobile communication device is illustratively operable to collect employee identification and location information, and to thereafter wirelessly transmit the same at step 548 to the main server 12 in embodiments in which such information has not yet been supplied to the main server 12. At step 550, the processor 50 of the main server receives the wirelessly transmitted information, whether transmitted by the employee's mobile communication device 16 at step 548 or as part of the process executed at step 544, and thereafter at step 552 the processor 50 of the main server 12 is operable to process the wirelessly received information and determine therefrom the identity of the employee and the identity/location of the one of the facilities 251-25L just entered or exited by the identified employee, e.g., by comparing the wirelessly received EID to the employee information stored in the employee database 304 and by comparing the facility identity/location data to facility location information stored in the facility location database 310.

Illustratively, the processor 50 is further operable at step 552 to determine the date and time at which the identified employee entered or exited the identified facility 25. In some embodiments, the dates and times of such events are determined by the processor 50 based on dates and times of receipt of the employee/facility data. In other embodiments, information wirelessly transmitted by the employee mobile communication devices 16 may include such date and time information, e.g., from on-board clocks and/or based on received GPS data. In any case, the processor 50 is further illustratively operable at step 552 to determine whether the identified employee entered or exited the identified facility. In some embodiments, the processor 50 is illustratively operable to determine such information by monitoring past exit/entrance activity stored in the employee database 304. Thus, for example, to be an exit from an identified facility 25, the employee database 304 would have stored therein a log of a previous entry into the identified facility by the identified employee, etc. Alternatively or additionally, the processor 50 may take into account other factors such as the present time of day, whether the identified employee thereafter accesses a computer or electronic machine in the identified facility, and the like. In other embodiments, one or more of the facilities 251-25L may include multiple ones of the employee/device recognition (EDR) devices 28, e.g., sequentially positioned, to determine employee direction of movement. Those skilled in the art will recognize other techniques for determining whether the identified employee is entering or exiting the identified one of the facilities 251-25L, and it will be understood that any such other techniques are contemplated by this disclosure.

Following step 552, the processor 50 is operable at step 554 to log the entry or exit time of the identified employee to/from the identified facility 25. Illustratively, the employee database 304 includes employee time and attendance records stored therein, and the processor 50 is illustratively operable to populate such records at step 554 based on the received employee entrance/exit information. Thereafter at step 556, the processor 50 is illustratively operable to enable and/or disable one or more assets owned or controlled by the business enterprise 11, such as one or more hardware devices and/or one or more software programs owned or controlled by the business enterprise 11 and used or otherwise accessible to the identified employee. Whether to enable or disable any such hardware devices and/or software programs may depend on several factors including, for example, but not limited to, whether the identified employee has entered or exited the identified facility 25, the function of the employee at the business enterprise 11, the position of the employee at the business enterprise 11, and the like. Examples of hardware devices that may be disabled by the processor 50 at step 554 upon a determination that the identified employee has exited the identified facility 25, and that may be enabled by the processor 50 at step 554 upon a determination that the identified employee has entered the identified facility 25, include, but are not limited to, one or more of the computers 241-24M, one or more of the machines 261-26N, one or more enterprise-owned or controlled ones of the mobile communication devices 161-16K, and the like. Examples of software programs that may be disabled by the processor 50 at step 514 upon a determination that the identified employee has exited the identified facility 25, and that may be enabled by the processor 50 at step 514 upon a determination that the identified employee has entered the identified facility 25, include, but are not limited to, workstation access software, one or more software applications executable in a workstation environment, stored user passwords or other user login information, email, one or more internet browsers, intra-net software, document storage and/or creation software, special purpose application software, and the like, whether accessible via any of the computers 241-24M, one or more of the machines 261-26N and/or one or more enterprise-owned or controlled ones of the mobile communication devices 161-16K. It will be further recognized that some software applications, e.g., one or more software applications accessible via one or more enterprise-owned, controlled or issued mobile communication device 161-16K, may be disabled upon entrance by employees into one or more of the facilities 251-25L, and/or may be enabled upon exit by employees from one or more of the facilities 251-25L. As used herein, the terms “enabled” and “disabled,” as used in the context of hardware devices and/or software programs, are intended to refer in some cases to grant or denial of access by others to hardware or software typically used by the identified employee, and in other cases are intended to refer to grant or denial of access by the identified employee to such hardware or software otherwise denied or granted to the identified employee.

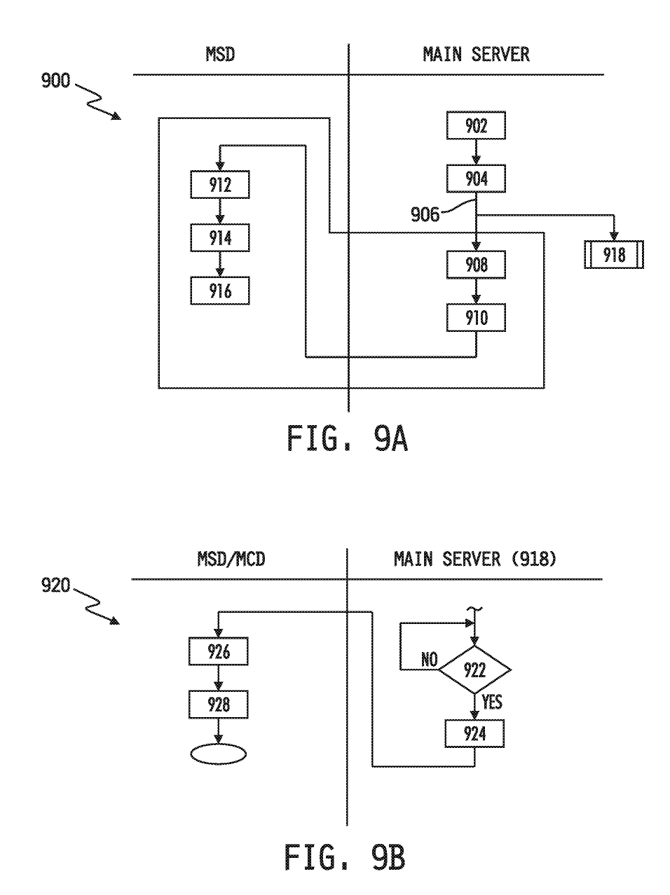

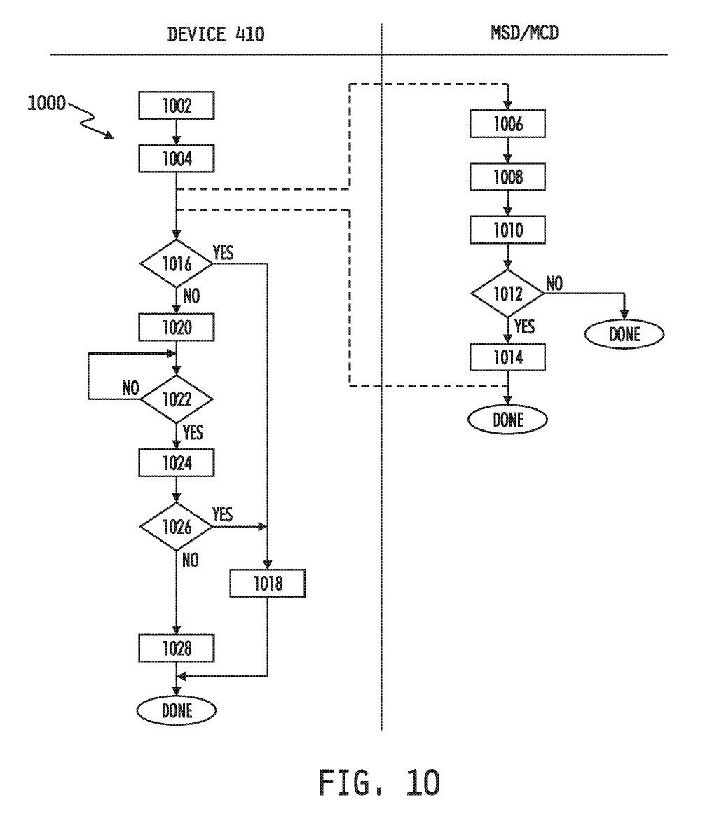

In some embodiments, it may be desirable to monitor and/or manage access by one or more employees to certain mobile devices. In such embodiments, for example, the process 540 may include step 558 where the processor 50 is operable to determine whether one or more mobile hardware assets were detected at the employee entrance/exit. In embodiments in which such mobile hardware assets include one or more employee mobile communication devices 161-16K, such devices are detectable via any of the processes described above. In other embodiments in which such mobile hardware assets may include one or more electronic or other assets that may be permissible removed from one or more of the facilities 251-25L, such as a lap top, notebook or tablet computer or other device or article, such assets may illustratively include, incorporate, have embedded therein or attached thereto, one or more electronic identification devices detectable by the employee/device recognition (EDR) devices 28 upon entrance and exit by employees from one or more of the facilities 251-25L. As illustrated by example in FIG. 4A, the employee 406 illustratively carries such a device or apparatus 408 which illustratively has an electronic identification device 410 attached thereto. Examples of such electronic identification devices may include, but are not limited to, RFID tags or devices, NFC devices or the like. In any case, the process 540 illustratively includes step 558 in such embodiments where the processor 50 is illustratively operable to determine whether any such mobile device was detected upon entrance/exit of the identified employee. If so, the process 540 advances to step 560 where the processor 50 is illustratively operable to determine whether the detected mobile device is a mobile communication device 161-16K or other mobile device. If the former, the process 540 advances to step 562 where a mobile communication device process is executed, and otherwise the process 540 advances to step 564 where a mobile device process is executed. An example embodiment of the mobile communication device process executed at step 562 is illustrated in FIG. 8 and will be described in detail hereinafter. Example embodiments of the mobile device process executed at step 564 are illustrated in FIGS. 9A-10 and will be described in detail hereinafter.

### Facility Identification Process Embodiments

Referring now to FIG. 7A, a simplified flow diagram is shown of an embodiment of an employee entrance/exit identification process 700 executed by the employee's mobile communication device at step 544 of the process 540 illustrated in FIG. 5B, i.e., for determining the identity of the one of the employer facilities 251-25L that the employee is entering or existing while carrying one of the mobile communication devices 161-16K. The framework of the process 700 illustrated in FIG. 7A is similar to that of FIG. 5B in which a portion of the process 700, i.e., the portion to the left of the left-most vertical line and centered under the heading “MCD,” illustratively represents one or more software applications executed by the processor 200 of an employee's mobile communication device 16, i.e., one of the mobile communication devices 161-16J associated with an employee of the business enterprise 11. In one embodiment, this portion of the process 700 is or includes the ATAM application 214 stored in the memory 204 (and/or data storage 206) of the employee's mobile communication device 16 in the form of instructions executable by the processor 200 of the employee's mobile communication device 16. The process steps of this portion of the process 700 will be described below for purposes of this disclosure as being executed by the processor 200 of the employee's mobile communication device 16.

Another portion of the process 700, i.e., the portion between the left-most vertical line and the right-most vertical line in FIG. 7A, and centered under the heading “EDR(S),” does not necessarily represent a portion of the process 700 that is stored in a memory of any system or server in the form of instructions executable by a processor. Rather, this portion of the process 700 illustratively represents operation of one or more employee/device recognition (EDR) devices 28 illustratively implemented in the embodiment illustrated in FIG. 7A in the form of one or more wireless signal broadcasting devices, e.g., radio frequency beacons, as described hereinabove with respect to FIG. 1, as such operation relates to the broadcast of wireless identification signals described hereinabove. It will be understood that the following description of the facility identification process 700 is provided only by way of example as such a process may relate to the implementation and use of wireless signal broadcasting devices as the employee/device recognition (EDR) devices 28, and it will be understood that the employee/device recognition (EDR) devices 28 are not limited to the implementation and use of such wireless signal broadcasting devices but rather may be implemented in any of the forms described herein.

Yet another portion of the process 700, i.e., the portion to the right of the right-most vertical in FIG. 7A, and centered under the heading “Main Server,” illustratively represents one or more software applications executed by the processor 50 of the main server 12. In one embodiment, this portion of the process 700 is stored in the ATAM processing module 342 in the form of instructions executable by the processor 50 of the main server 12. The process steps of this portion of the process 700 will be described below for purposes of this disclosure as being executed by the processor 50 of the main server 12. In some alternate embodiments, e.g., that may or may not include a main server 12, this portion of the process 700 may alternatively be stored in the memory 34 (and/or data storage 36) of one or more of the local servers 22 in the form of instructions executable by the processor 30 of the one or more local servers 22 and/or stored in a memory and executable by a processor of another system external to or supplemental to the system 10 illustrated FIG. 1. It will further be understood that portions of the process 700 illustrated as being executed by one processor/device or one processor/server or one processor/system may alternatively be executed by a different processor/device or processor/server or processor/system in the system 10, and/or by two or more such processors in any one or combination of such devices, servers and/or systems, some examples of which are described above.

In the process 700 illustrated in FIG. 7A, item 702 illustratively identifies action taken by the one or more wireless signal broadcasting devices 28 positioned at, in, or near one or more of the employee entrances/exits to/from any of the facilities 251-25L of the business enterprise 11. In particular, the one or more wireless signal broadcasting devices 28 illustratively operate(s) to continuously or periodically broadcast wireless identification signals, each of which carry decodable information in the form of a unique identification code (UID) as described hereinabove with respect to FIG. 1. In some embodiments, such signals may be periodically or non-periodically broadcast by the one or more wireless signal broadcasting devices 28 and in other embodiments some such wireless signal broadcasting devices may periodically broadcast wireless signals and others of the wireless signal broadcasting devices may broadcast wireless signals non-periodically. In still other embodiments, one or more such wireless signal broadcasting devices may sometimes periodically broadcast wireless signals and at other times broadcast wireless signals non-periodically. In any case in embodiments in which such wireless signal broadcasting devices 28 continuously or continually broadcast wireless signals, the process advances to step 704 where the wireless communication circuitry 316 of the employee's mobile communication device 16 is illustratively operable to detect any such broadcast wireless identification signals within the broadcast range of which the mobile communication device 16 is located as the term “broadcast range” is described herein.

In some alternative embodiments, one or more wireless signal broadcasting devices 28 may be selectively operable to periodically or non-periodically broadcast wireless identification signals. In such embodiments, one or more such wireless signal broadcasting devices may, for example, be responsive to one or more control signals produced by the processor 50 of the main server, the processor 30 of one of the local hub servers 22 and/or other processor(s) associated with the one or more other devices and/or systems within the facility or the business enterprise 11, to selectively wake up or otherwise activate and begin broadcasting wireless identification signals, and to selectively deactivate and cease broadcasting wireless signals. In some embodiments, the facility 25 may include one or more conventional proximity or motion-detecting sensors, e.g., one or more such sensors at or near the one or more wireless signal broadcasting devices 28 and production of such control signals may be triggered by proximity or motion signals produced by such sensors. In other embodiments, production of such control signals may, for example, be triggered by the processor 50, e.g., in response to certain operating hours of one or more of the facilities 25 of the business enterprise 11. Those skilled in the art will recognize that any modifications required to implement and integrate one or more steps of any such alternate embodiment into the process 700 would be a mechanical step for a skilled programmer, and that such alternate embodiments therefore fall within the scope of this disclosure.

The processor 200 of the employee's mobile communication device 16 is operable at step 704 to detect unique identification signals wirelessly broadcast by any in-range wireless signal broadcasting device 28 at the time of execution of step 704. In the implementation illustrated in FIG. 4A, for example, at least one wireless signal broadcasting device 28 is positioned adjacent to the employee entrance/exit 402 and at least one wireless signal broadcasting device 28 is likewise positioned adjacent to the employee entrance/exit 404 through which the employee 406 is passing. As the employee 406 passes through the employee entrance/exit 404, the employee's mobile communication device 16 is illustratively operable to detect wireless identification signals broadcast by the adjacent wireless signal broadcasting devices(s) 28. If the ATAM application 216 is active and being executed by the processor 200 as the employee passes through the employee entrance/exit, such detection illustratively occurs automatically as the employee's mobile communication device 16 approaches the wireless signal broadcasting device(s) 28. In some embodiments, if the ATAM application 216 is not currently active and being executed by the processor 200, detection by the employee's mobile communication device 16 of wireless signals broadcast by the wireless signal broadcasting devices(s) 28 as the employee approaches the wireless signal broadcasting devices(s) 28 illustratively wakes up and activates the ATAM application 216. In either case, this scenario is illustrated in FIG. 4B which depicts an employee's mobile communication device 16 passing by one of the wireless signal broadcasting devices 28 positioned at or adjacent to an employee entrance/exit, e.g., the employee entrance/exit 404 illustrated in FIG. 4A.

Referring now to FIG. 4B, a communications framework is shown for detecting by employee mobile communication devices 161-16J of wireless identification signals broadcast by one or more wireless signal broadcasting devices(s) 28 at step 704, as described above, and for conducting wireless communications relating thereto between the employee mobile communication devices 161-16J and the main server 12 of the retail enterprise 11. In the illustrated embodiment, a wireless signal broadcasting devices 28 is shown coupled to the local hub server 22, and the local hub server 22 is coupled to the main server 12 via the private network 20 as illustrated and described with respect to FIG. 1. In embodiments which do not include the local hub server 22, the wireless signal broadcasting device 28 may be coupled directly to the main server 12 via the private network 20. In other embodiments, the wireless signal broadcasting device 28 may not be communicatively coupled to either the local hub server 22 or the main server 12.

As the communication framework depicted in FIG. 4B relates to any of the wireless signal broadcasting devices 28, such as the wireless signal broadcasting device 28 depicted in FIG. 4A located adjacent to the employee entrance/exit 404, a mobile communication device 16 carried by an employee passing through the associated employee entrance/exit will be able to detect wireless signals broadcast by the wireless signal broadcasting device 28, i.e., such that the wireless signal broadcasting device 28 will be in-range relative to the employee's mobile communication device 16 as the term “in-range” is defined below. Each such wireless signal broadcasting device 28 is illustratively configured to broadcast wireless identification signals with a predefined orientation (i.e., direction) and broadcast range. In the example illustrated in FIG. 4A, the wireless signal broadcasting device 28 is illustratively configured and operable to broadcast wireless identification signals directionally toward the employee entrance/exit 404, and such directional signal broadcasting is indicated in FIG. 4B by the dashed-line open rings emanating from the wireless signal broadcasting device 28. In some embodiments, any of the wireless signal broadcasting devices 28 may alternatively be configured and operable to broadcast wireless identification signals concentrically thereabout. Those skilled in the art will recognize that any of the wireless signal broadcasting devices 28 may alternatively be configured and operable to broadcast wireless identification signals in any desired direction relative to the wireless signal broadcasting device and/or with any desired orientation, and it will be understood that any such alternative wireless identification signal broadcast direction and/or orientation is/are contemplated by this disclosure.

Each wireless signal broadcasting device 28 is further illustratively configured to broadcast a wireless identification signal with a predefined broadcast range. Generally, the broadcast range of any wireless signal broadcasting device 28 illustrated and described herein should be understood to be defined by an area relative to that wireless signal broadcasting device 28 within which the signal strength of wireless signals broadcast thereby is sufficient to be detected by the communication circuitry 208 of the employee mobile communication devices 161-16J, and outside of which the signal strength of wireless signals broadcast thereby is undetectable by the communication circuitry 208 of the employee mobile communication devices 161-16J. As used in the previous sentence, the term “undetectable” should be understood to mean any of indistinguishable by the communication circuitry 208 of the employee mobile communication devices 161-16J from background electromagnetic noise, distinguishable by the communication circuitry 208 of the employee mobile communication devices 161-16J from background electromagnetic noise but not decodable by the communication circuitry 208 of the employee mobile communication devices 161-16J or distinguishable by the communication circuitry 208 of the employee mobile communication devices 161-16J from background electromagnetic noise but not decodable by communication circuitry of any electronic device or system to which the communication circuitry 208 of the employee mobile communication devices 161-16J may transmit or otherwise relay the wireless broadcast signal(s).

As described hereinabove with respect to FIG. 1, each of the wireless signal broadcasting devices 28 is illustratively operable to broadcast one or more unique wireless identification signals which distinguish each particular wireless signal broadcasting device 28 from others of the wireless signal broadcasting devices 28 located at the same facility 251-25L, and in other embodiments also from all others of the wireless signal broadcasting devices 28 within the business enterprise 11. At some point, while the wireless signal broadcasting devices 28 are broadcasting one or more unique wireless identification signals, an employee carrying the employee's mobile communication device 16 may approach a location at which a wireless signal broadcasting device 28 is positioned as illustrated in FIG. 4B in which the employee's mobile communication device 16 is shown adjacent to the wireless signal broadcasting device 28 (as also illustrated in FIG. 4A). The employee's mobile electronic device 16 and the main server 12 are each illustratively configured to communicate wirelessly with each other via the public network 14 as also shown in FIG. 4B, and in some embodiments the facility 251-25L may illustratively implement one or more local or wide area networks for the purpose of providing or enhancing wireless communication access by employee mobile communication devices 161-16J to the public network 14.

In any case, as the mobile communication device 16 carried by the employee approaches the wireless signal broadcasting device 28, e.g., as the employee 406 passes through the employee entrance/exit 404 as illustrated in FIG. 4A, the employee's mobile communication device 16 enters a space that is within the broadcast range of the wireless signal broadcasting device 28 as illustrated in FIG. 4B, and when within the broadcast range of the wireless signal broadcasting device 28 the customer's mobile communication device 16 is able to detect the unique identification signals being broadcast thereby. Illustratively, the broadcast range of the wireless signal broadcasting device 28 is sufficiently large, wide and/or oriented so as to be detectable by employee mobile communication devices 161-16J when employees carrying such mobile communication devices 161-16J pass through an employee entrance/exit as illustrated in FIG. 4A. Further illustratively, the broadcast range of the wireless signal broadcasting device 28 is, at the same time, sufficiently small, narrow and/or oriented so as to provide a desired amount or degree of resolution in determining the location of a customer's mobile communication device 16 relative to the wireless signal broadcasting device 28 and/or relative to another beacon located at a different employee entrance/exit to/from the facility 25, e.g., the employee entrance/exit 402 illustrated in the example of FIG. 4A. The general communication framework depicted in FIG. 4B is illustratively used in the process 700 illustrated and described below for detecting by employee mobile communication devices 161-16J of wireless identification signals broadcast by at least one wireless signal broadcasting device 28 located at or near one or more employee entrances/exits to/from one or more facilities 251-25L, and in any case also for conducting wireless communications between such employee mobile communication devices 161-16J and the main server 12 of the business enterprise 11.

Following step 704, the process 700 advances to step 706 where the processor 200 of the employee's mobile communication device 16 is responsive to detection of wireless identification signals broadcast by any in-range wireless signal broadcasting device 28 to transmit one or more wireless signals to the main server 12, e.g., to control the communication circuitry 208 in the device 16 to wirelessly transmit one or more signals to the main server 12 via the public network 14. The one or more wireless signals illustratively contain(s) the unique identification (UID) of an in-range wireless signal broadcasting device as well as an employee identification code, EID, which identifies the employee carrying the mobile communication device 16 and/or which identifies the mobile communication device 16.

In one embodiment, the memory 204 or data storage 206 of the employee's mobile communication device 16 may have stored therein the employee identification code, EID, in the form of an identifier which identifies the employee associated with, i.e., that carries, the mobile communication device 16. In some such embodiments, EID illustratively is or includes the employee's employee number or code used by the business enterprise and stored in the employee database 304, or is another number, code or set of numbers and/or codes to which the employee's employee number or code is linked or from which the employee's employee number or code can otherwise be determined by the processor 50 of the main server 12. In other alternate embodiments, the memory 204 or data storage 206 of the mobile communication device 16 may have stored therein the employee identification code, EID, in the form of communication information which identifies the mobile communication device 16 for purposes of wirelessly communicating therewith, e.g., a mobile telephone number and/or other communication identifier, which identifies the employee's mobile communication device 16 to the main server 12 for the purpose of communicating information from the main server 12 back to the employee's mobile communication device 16. In such embodiments, the employee database 304 illustratively includes such communication information for each employee which has the ATAM application 214 stored in a mobile communication device 16 carried by the employee, and in some embodiments the employee database 304 includes such communication information for each employee of the business enterprise 11. In any case, such communication information is illustratively linked to or otherwise associated with one or more data components of the employee located in the employee database 304 such that the processor 50 can search the employee database 304 by communication information to locate the employee's communication information and identify the employee by employee information associated therewith in the employee database 304. In any case, the employee's mobile communication device 16 is illustratively operable, at step 706, to transmit to the main server 12 an employee identification code, EID, whether in the form of an identifier of the employee, such as the employee's employee number or code or other identifier, or in the form of an identifier of the employee's mobile communication device 16, such as the communication information of the employee's mobile communication device 16. Those skilled in the art will recognize other employee identifiers which may be stored in the employee's mobile communication device 16 and which may be wirelessly transmitted by the employee's mobile communication device 16 at step 706.

In one embodiment, the processor 200 of the employee's mobile communication device 16 is further operable at step 704 to process the wireless identification signals broadcast by an in-range one of the wireless signal broadcasting devices 26 to determine therefrom the UID of the in-range wireless signal broadcasting device 28, and to include the UID thereof in the one or more wireless signals transmitted by the employee's mobile communication device 16 to the main server 12 at step 706. In other embodiments, the processor 200 may be operable at step 704 to include in the one or more wireless signals transmitted by the employee's mobile communication device 16 to the main server 12 at step 706 only the raw signal content of the detected wireless identification signals. In such embodiments, the processor 50 of the main server 12 may be operable to thereafter process the raw signal content transmitted thereto by the employee's mobile communication device 16 to determine therefrom the UID of a corresponding in-range wireless signal broadcasting device.

Following step 706, the main server 12 is operable at step 708 to receive the one or more wireless signals transmitted by the employee's mobile communication device 16 at step 706, and the processor 50 of the main server 12 is thereafter operable at step 710 to process the UID contained therein to determine the identity of the in-range one of the wireless signal broadcasting devices whose wirelessly broadcast identification signals were detected by the employee's mobile communication device 16 at step 704, and to also determine the location of the detected wireless signal broadcasting device. The wireless signal broadcasting device location may be, for example, the location of the facility 251-25L in which the detected beacon is located and/or the location of the detected beacon relative to a particular structure or location within a particular facility 251-25L, e.g., relative to a particular one of multiple employee entrances/exits.

The EDR data 314 illustratively has stored therein wireless signal broadcasting device identity information for each wireless signal broadcasting device in the business enterprise 11, and such wireless signal broadcasting device identity information illustratively includes information from which the processor 50 can determine, for each such wireless signal broadcasting device, the identity of the facility 251-25L at which each such wireless signal broadcasting device is located, and/or the relative location or position of that wireless signal broadcasting device within an identified facility 251-25L. Illustratively, the wireless signal broadcasting device identity information stored in the facility location database 310 includes at least the UIDs for each of the wireless signal broadcasting devices in the business enterprise 11. In some embodiments, each such UID may further include or be associated with, e.g., linked to, mapped to, or otherwise identified in the facility location database 308 with, a facility identifier (FID), e.g., in the form of a designation number or code, which identifies the corresponding one of the facilities 251-25L of the business enterprise in which the corresponding wireless signal broadcasting device 26 is located. The facility identifiers, FID, in embodiments which include such facility identifiers, are illustratively stored in the form of facility numbers or codes, such as facility 3 or facility G6. In other embodiments, the facility location identifiers may include additional information such as city, state or country identifier or the like. Those skilled in the art will recognize other techniques and/or codes that may be used to identify such facility locations where particular wireless signal broadcasting devices are located, and it will be understood that any such other techniques and/or codes are contemplated by this disclosure.

In some embodiments, each such UID may alternatively or additionally include or be associated with, e.g., linked to, mapped to, or otherwise identified in the facility location database 310 with a wireless signal broadcasting devices location identifier (BID), e.g., in the form of a designation code or other identifier which identifies a location or position of the corresponding wireless signal broadcasting device relative to a reference position and/or structure within all facilities 251-25L, e.g., in embodiments in which all such facilities 251-25L are identically configured, or which identifies a location or position of the corresponding wireless signal broadcasting device relative to a reference position and/or structure within a particular one of the facilities 251-25L. In some embodiments of the latter case, the BID may include one or more codes or other identifiers which identify both the particular one of the facilities 251-25L in which the wireless signal broadcasting device in located and a location or position within the identified facility 251-25L. In other embodiments in which the UID is associated with a FID and a BID, the BID may include one or more codes or other identifiers which identify the position or location of the wireless signal broadcasting device within the facility identified by FID. In any case, the wireless signal broadcasting device location identifiers, BID, are, in some embodiments, illustratively stored in the form of location coordinates relative to a base or reference set of coordinates. In some alternate embodiments, the wireless signal broadcasting device location identifiers, BID, may be stored in the form of one or more location codes identifying a particular employee entrance and/or exit within all or an identified one of the plurality of facilities 251-25L. As one specific example in which a wireless signal broadcasting device 28 is located at or near the employee entrance/exit 404 of the facility 25 illustrated in the example of FIG. 4A, the BID may be 404. As another specific example in which FID and BID are combined in to a single code and in which a wireless signal broadcasting device 28 is located at or near the employee entrance/exit 404 as illustrated in the example of FIG. 4A, the combined FIDBID may be 25404.

It will be understood that the wireless signal broadcasting device identity information stored in the facility location database 310 may include separately stored but associated values or codes for UID and any one or combination of FID and BID, or may be one or more codes or identifiers which include UID and any one or combination of FID and/or BID. Those skilled in the art will recognize other techniques and combinations for identifying and storing the wireless signal broadcasting device identity information stored in the facility location database 310, and it will be understood that this disclosure contemplates any technique(s) or combination(s) of information from which the identity and/or location of a wireless signal broadcasting device can be determined by the processor 50 based on a UID wirelessly transmitted by the employee's mobile communication device 16 at step 606 and received by the main server 12 at step 708.

In any of the foregoing embodiments, the processor 50 is illustratively operable at step 710 to process a UID wirelessly received from the employee's mobile communication device 16 by searching for a corresponding UID stored in the facility location database 310 or other database that matches the wirelessly received UID. The processor 50 further illustratively operable at step 610 to identify the wireless signal broadcasting device location information, e.g., FID and/or BID, associated in the facility location database 310 or other database with the matching UID.

In some alternate embodiments, the process steps 704-710 just described may be replaced by steps in which the memory 204 and/or data storage 206 of the employee's mobile communication device 16 illustratively has wireless signal broadcasting device information stored therein, e.g., as part of the ATAM application 214, which relates to some or each of the various wireless signal broadcasting devices 28 in one or more of the facilities 251-25L of the business enterprise 11. In such embodiments, the processor 200 of the employee's mobile communication device 16 may be operable to process the UID information received from the wireless signal broadcasting device 28 to determine the location of the employee's mobile communication device 16, e.g., as one of the facilities 251-25L and/or as a location within and relative to one of the facilities 251-25L, as described above with respect to step 610. Those skilled in the art will recognize that any modifications to the process 600 required to implement such alternative steps would be a mechanical step for a skilled programmer, and it will therefore be understood that such an alternative process falls within the scope of this disclosure.

In any case, the process 700 advances from step 710 to step 712 where the processor 50 is illustratively operable to determine whether the EID code transmitted to the main server 12 by the employee's mobile communication device 16 matches an EID code stored in one or more databases, i.e., whether the EID code matches a corresponding EID code stored in the employee database 304 or other database. The processor 50 is illustratively operable to execute step 712 of the process 700 by searching for the EID code in the employee database 304 in embodiments in which the EID codes are stored in the employee database 304, or in one or more other databases in which EID codes are stored in embodiments in which the EID codes are stored in such one or more other databases. Following execution of step 712, the process 700 returns to step 544 of the process 540 with the identity, EID, of the employee carrying the mobile communication device 16 and with the location of the employee's mobile communication device, e.g., as the one of the facilities 251-25L into which the employee's mobile communication device 16 has just entered or exited and/or as the entrance/exit of an identified one of the facilities 251-25L through which the employee's mobile communication device has just passed.

It will be understood that the process 700 just described may be alternatively used with other implementations of the employee/device recognition (EDR) devices 28, such as, for example, transponders, radio-frequency identification (RFID) devices, near-field communication (NFC) devices, far-field communication devices, telemetry devices, automated identification and data capture (AIDC) devices or the like. Those skilled in the art will recognize that any modifications to the process 700 to accommodate any such alternate implementation of one or more EDR devices 28 would be a mechanical step for a skilled artisan, and it will therefore be recognized that any such alternate implementations fall within the scope of this disclosure.

Referring now to FIG. 7B, a simplified flow diagram is shown of another embodiment of a facility identification process 750 that may be executed by the employee's mobile communication device at step 544 of the process 540 illustrated in FIG. 5B, i.e., for determining the identity of the one of the facilities 251-25L into or out of which the employee's mobile communication device 16 has just passed. The framework of the process 750 illustrated in FIG. 7B is identical to that illustrated in FIG. 5B, and the portion of the process 750 centered under the heading “MCD,” illustratively represents one or more software applications executed by the processor 200 of an employee's mobile communication device 16, i.e., one of the mobile communication devices 161-16J associated with an employee of the business enterprise 11, and the portion centered under the heading “Main Server” illustratively represents one or more software applications executed by the processor 50 of the main server 12. In one embodiment, the left portion of the process 750 is or includes the ATAM application 214 stored in the memory 204 (and/or data storage 206) of the employee's mobile communication device 16 in the form of instructions executable by the processor 200 of the employee's mobile communication device 16. The process steps of this portion of the process 750 will be described below for purposes of this disclosure as being executed by the processor 200 of the employee's mobile communication device 16. The right portion of the process 750 is illustratively stored in the ATAM processing module 342 in the form of instructions executable by the processor 50 of the main server 12. The process steps of this portion of the process 750 will be described below for purposes of this disclosure as being executed by the processor 50 of the main server 12. In some alternate embodiments, e.g., that may or may not include a main server 12, this portion of the process 750 may alternatively be stored in the memory 34 (and/or data storage 36) of one or more of the local servers 22 in the form of instructions executable by the processor 30 of the one or more local servers 22 and/or stored in a memory and executable by a processor of another system external to or supplemental to the system 10 illustrated FIG. 1. It will further be understood that portions of the process 750 illustrated as being executed by one processor/device or one processor/server or one processor/system may alternatively be executed by a different processor/device or processor/server or processor/system in the system 10, and/or by two or more such processors in any one or combination of such devices, servers and/or systems, some examples of which are described above.

The process 750 begins at step 752 where the processor 200 of the employee's mobile communication device 16 is illustratively operable to determine a position or location of the device 16, and thereafter at step 754 the processor 200 is operable to wirelessly transmit one or more signals to the main server 12 which illustratively include(s) the position or location of the device 16 and an employee identification code, EID, stored in the memory 204 or data storage 206 of the device 16, the latter of which may be as described above with respect to the process 700 illustrated in FIG. 7A. In one embodiment of the process 750, the processor 200 is illustratively operable to execute step 752 by determining a geographic location of the mobile communication device 16, e.g., by receiving and processing geographic location coordinates from the on-board GPS receiver 200 or, in some embodiments, by processing geographical coordinates most recently received from the on-board GPS receiver 200. In such embodiments, the processor 200 is illustratively operable at step 754 to wirelessly transmit to the main server 12 the employee identification code, EID, and the raw or processed GPS coordinates determined at step 752.

Following step 754, the main receiver 12 receives the wirelessly transmitted employee identification code at step 756. Thereafter at step 758, the processor 50 of the main server 12 is operable to process the geographic location information transmitted by the employee's mobile communication device 16 at step 754 to determine the current position or location of the employee's mobile communication device 16. In such embodiments, the facility location database 310 illustratively includes location coordinate information for one or more of the facilities 251-25L, and the processor 50 is illustratively operable to execute step 658 by comparing the wirelessly received geographic information with the store location coordinate information stored in the database 510.

In some such embodiments, the facility location coordinate information is stored in the facility location database 310 in the form of geo-fence data, i.e., geographic coordinate data that defines a boundary about, or at least partially about, one or more defined geographic point locations. In such embodiments, a geo-fence is defined about, or partially about, one or more of the facilities 251-25L and one or more such geo-fences is/are stored in the database 310 and each such stored geo-fence is associated in the database 310 with a corresponding one of the facilities 251-25L. In such embodiments, the processor 50 is illustratively operable to execute step 758 by comparing the wirelessly received geographic information with the one or more geo-fences stored in the database 310 and identifying as the one of the facilities 251-25L into which the employee's mobile communication device 16 has just entered or from which the employee's mobile communication device 16 has just exited as the facility associated in the database 310 with the geo-fence that matches or most closely matches the wirelessly received geographic information.

In other embodiments in which the facility location database 310 includes location coordinate information for one or more of the facilities 251-25L, such location coordinate information may be stored in the form of one or more location coordinates that identify one or more of the facilities 251-25L, e.g., geo-fence data or other set of geographic coordinates, and that further identify one or more locations and/or structures within one or more of the facilities 251-25L. In such embodiments, the processor 50 is illustratively operable to execute step 758 by comparing the wirelessly received geographic information with the location coordinates stored in the database 310 to identify the one of the facilities 251-25L into which the employee's mobile communication device 16 has just entered or out of which the employee's mobile communication device 16 has just exited, and/or to identify a specific location or structure, e.g., one of the employee entrances/exits 402, 404 illustrated in FIG. 4A, within an identified one of the facilities 251-25L at or near which the employee's mobile communication device is presently located or has just exited.

In any case, the process 750 advances from step 758 to step 760 where the processor 50 is illustratively operable to determine whether the EID code transmitted to the main server 12 by the employee's mobile communication device 16 at step 754 matches an EID code stored in one or more databases, e.g., as described hereinabove with respect to step 712 of the process 700. Following execution of step 760, the process 750 returns to step 544 of the process 540 with the identity, EID, of the employee carrying the mobile communication device 16 and with the location of the employee's mobile communication device, e.g., as the one of the facilities 251-25L into which the employee's mobile communication device 16 has just entered or from which the employee's mobile communication device 16 has just exited and/or as the location of the employee's mobile communication device relative to an identified one of the facilities 251-25L in which the employee's mobile communication device 16 is currently located or has just exited.

In some alternate embodiments, at least one of the employee/device recognition (ERD) device 28 may illustratively be implemented in the form of a conventional barcode reading device, and the employee's EID code may be displayed or displayable on the display 218 of the employees mobile communication device 16 as part of the ATAM application 214 executed by the processor 200. In such embodiments, the displayed EID code may illustratively be displayed in the form of a conventional linear or one-dimensional barcode or may be alternatively displayed in the form of a two-dimensional matrix code, such as a QR code or the like, or may be alternatively still be displayed in the form of a hybrid or composite barcode. In any case, the main server 12 is illustratively operable in such embodiments to determine the identities of employees entering or leaving any of the facilities 251-25L by processing the barcode scanned by the barcode reading device 28 and comparing the results to the employee database 304 as described above with respect to the process 700 of FIG. 7A. The main server 12 is further illustratively operable in such embodiments to determine the location of such employees, i.e., the facility 25 and/or particular employee entrance/exit thereof through which the employee is entering or exiting the facility by processing identification information associated with the ERD device 28 and comparing the results to corresponding location information stored in the facility location database 310.

In other some alternate embodiments, at least one of the employee/device recognition (ERD) device 28 may illustratively be implemented in the form of an electronic display or other such controllable visual device, and the employee's EID code may be stored in the memory 204 or data storage 206 of the employee's mobile communication device 16. In such embodiments, the processor 50 may be operable to control the electronic display to change periodically, and the ATAM application executing on employee communication devices 16 may be configured to activate the—an on-board camera 222 and control the display 218 to prompt employees to capture an image of the ERD with the camera 222 when entering and/or exiting a facility 25. In such embodiments, the processor 200 may be operable to wirelessly transmit the captured image and the employee's EID to the main server 12, and the processor 50 may be operable to process such information to determine the identity of the employee, the identity of the facility just entered or exited by the employee and the date and time of this occurrence. In some embodiments, the ERD may display date and time, and in other embodiments the captured images may be date and time stamped with GPS data as is known in the art. In any case, the main server 12 is further illustratively operable in such embodiments to process such data wirelessly received from the employee's mobile communication device 16 to determine the identity and location of such employees, i.e., the facility 25 and/or particular employee entrance/exit thereof through which the employee is entering or exiting the facility by processing identification information associated with the ERD device 28, e.g., by comparing the results to corresponding location information stored in the facility location database 310 and to corresponding employee data stored in the employee database 304.

### Employee Tracking Process

Referring now to FIG. 5C, a simplified flow diagram is shown of a process 570 for executing the employee tracking process of step 538 of the process 500 illustrated in FIG. 5A. The framework of the process 570 illustrated in FIG. 5C is illustratively identical to that illustrated in FIG. 6A, and the portion of the process 570 centered under the heading “MCD” illustratively represents one or more applications executed by the processor 200 of an employee's mobile communication device 16, i.e., one of the mobile communication devices 161-16J associated with an employee of the business enterprise 11, and the portion centered under the heading “Main Server” illustratively represents one or more applications executed by the processor 50 of the main server 12. The portion of the process 570 centered under the heading “EDR(S)” illustratively represents not any portion of the process 570 per se, but rather represents the independent operation (independent of the operation of the process 570) of the one or more EDR(S) 28. In one embodiment, the left portion of the process 570 is or includes the ATAM application module 214 stored in the memory 204 (and/or data storage 206) of the employee's mobile communication device 16 in the form of instructions executable by the processor 200 of the employee's mobile communication device 16. The process steps of this portion of the process 570 will be described below for purposes of this disclosure as being executed by the processor 200 of the employee's mobile communication device 16. The right portion of the process 570 is illustratively stored in the ATAM processing module 342 in the form of instructions executable by the processor 50 of the main server 12. The process steps of this portion of the process 570 will be described below for purposes of this disclosure as being executed by the processor 50 of the main server 12. In some alternate embodiments, e.g., that may or may not include a main server 12, this portion of the process 570 may alternatively be stored in the memory 34 (and/or data storage 36) of one or more of the local servers 22 in the form of instructions executable by the processor 30 of the one or more local servers 22 and/or stored in a memory and executable by a processor of another system external to or supplemental to the system 10 illustrated FIG. 1. It will further be understood that portions of the process 570 illustrated as being executed by one processor/device or one processor/server or one processor/system may alternatively be executed by a different processor/device or processor/server or processor/system in the system 10, and/or by two or more such processors in any one or combination of such devices, servers and/or systems, some examples of which are described above.

The process 570 begins at step 574 where the communication circuitry 208 of the employee mobile communication device 16 detects wireless signals broadcast by one (or more) of the EDR(S) illustratively provided in the form of one or more wireless signal broadcasting devices, e.g., radio frequency beacons or other wireless signal broadcasting devices. Thereafter at step 576, the processor 200 is operable to control the communication circuitry 208 to wirelessly transmit to the main server 12 wireless signals containing a unique identification (UID) signal or code broadcast by the detected wireless signal broadcasting device 28 and also containing the employee identification signal or code (EID) contained in the memory 204 of the mobile communication device, all as described above with reference to FIG. 7A. Thereafter at step 578, the communication circuitry 58 of the main server 12 is operable to receive the wirelessly transmitted signals and at step 580 the processor 50 is operable to process the UID to determine the location of the mobile communication device 16.

In the illustrated embodiment, the processor 50 is operable to track an employee carrying a mobile communication device 16 within an employer facility while the employee is working, i.e., scheduled and clocked in. In the context of the EDR(S) implemented in the above examples, wireless signal broadcasting devices 28 are illustratively implemented in many locations throughout the employer facility such that the present location of the employee can be determined by the processor 50. In the example illustrated in FIG. 11, for example, which should not be considered limiting in any way, a portion of a facility 25 is shown in which two work zones Z1 and Z2 are established as described above. Also shown in FIG. 11 are a number of spaced-apart wireless signal broadcasting devices 28 implemented in the facility 25 in an example grid pattern. The number of such wireless signal broadcasting devices 28 used, as well as the implementation pattern used to distribute the number of wireless signal broadcasting devices within the facility 25, will typically be driven by the expected accuracy of the employee's position or location within the facility. In the example illustrated in FIG. 11, for instance, it may be desirable to determine whether an employee 4061 carrying a mobile communication device 161 and assigned to work in the work zone Z1 is located within Z1 or outside of Z1. As illustrated in FIG. 11, only a single wireless signal broadcasting device 28 is needed to make such a determination. However, the same is not true of an employee 4062 carrying a mobile communication device 162 and assigned to work in zone Z2. With the number and distribution of wireless signal broadcasting devices 28 used in this example, two such devices 28 are required to determine whether or not the employee 4062 is located within the work zone Z2 as the range of each such wireless signal device 28 is not sufficient to ensure detection of the wireless broadcast signals by the mobile communication device 162 depending upon where in the work zone Z2 the employee 4062 is located.

In some embodiments, the facility identifier (FID) associated with the UID may be a sufficiently accurate indicator of the employee's position, and in other embodiments, as illustrated in FIG. 11, two or more wireless signal broadcasting device identifiers (BID) may be necessary to determine the present location of the employee within a desired accuracy. It should thus be understood that the desired degree or amount of accuracy of the employee's present position may dictate not only the number and placing of the wireless signal broadcasting devices 28 within an employer facility or portion thereof, but may also dictate the type and range of wireless signal broadcasting device identity information to be stored in the EDR data 314 of the server database 302 and later recalled by the processor 50 in making such employee location determinations.

Following step 580, the processor 50 is operable at step 582 to process the EID wirelessly received at step 578 and determine therefrom the identity of the employee carrying the mobile communication device 16, e.g., by comparing the EID with information in the employee database 304. Thereafter at step 584, the processor 50 is operable to compare the employee's present position, as determined at step 582, with an expected or assigned position of the employee. In the employee database 304, for example, scheduling information for each employee illustratively includes assignment location information indicating where, within an employer facility, the employee will be working. The assignment location information may illustratively be or include an assigned work zone, as illustrated by example in FIG. 11 and described in detail above, although in other embodiments the assignment location information may be or include one or more structural objects or devices, e.g., one of the POS systems 221-22M one of the machines 261-26N, one of the computers 241-24M, or the like. In any case, the facility location data 310 may further include information, e.g., in the form of one or more maps, lists, charts or tables, identifying physical locations within the employer facilities. The processor 50 may use any such information at step 584 to determine the assigned location of the employee as well as the present location of the employee and to make a comparison between the two, and/or may use any additional information stored in the database 402 or otherwise accessible to the processor 50 from which the processor 50 can determine such information.

Following step 584, the processor 50 is operable at step 586 to determine whether the identified employee is presently located at or within the employee's assigned location, e.g., based on the comparison just described. If so, the process 570 loops back to step 578. If not, the process 570 advances to step 586 where the processor 50 is operable to determine whether the employee is presently on a scheduled work break, e.g., via scheduling information in the employee database 304. If so, the process advances, in some embodiments, to step 507 where the processor 500 illustratively executes an employee off-schedule process. In other embodiments, the “YES” branch of step 588 may loop back to step 578 without executing any such off-schedule process.

If, at step 588, the processor 50 determines that the employee is not presently scheduled for a work break, the process 570 advances to step 590 where the processor 50 is operable to log the event and then at step 592 and 594 the processor 50 is operable to control the communication circuitry 58 to wirelessly transmit one or more messages to the employee and/or to the employee's supervisor. At steps 592 and 594, the employee has been found to be neither at the employee's assigned location nor on a scheduled break. In one embodiment, the one or more messages wirelessly transmitted by the processor 50 may be or include a message or notification to the employee to return to the employee's assigned work location and/or may be or include a message or notification to the employee's supervisor informing of the event. In the former case, the employee's mobile communication device 16 receives the message at step 596, and thereafter at step 598 the processor 200 controls the display 218 to display the message. Thereafter, the process 570 loops back to step 574.

In some embodiments, the process 570 may be executed periodically, or on an ad hoc basis. In other embodiments, the process 570 may be executed continually. In any such embodiments, the processor 200 may operate to check for or sample wireless broadcast signals and in other embodiments continually. In some embodiments, the processor 200 may be operable to periodically or continually check for or sample wireless signals broadcast by the one or more wireless signal broadcasting devices 28, as represented by the dashed line arrow between the steps 574 and 572.

### Employee Off-Schedule Process

### Embodiment 1

Referring now to FIG. 6A, a simplified flow diagram is shown of an embodiment of a process 600 for executing the employee off-schedule process executed at step 507 of the process 500 of FIG. 5A and the process 570 of FIG. 5C. The framework of the process 600 illustrated in FIG. 6A is identical to that illustrated in FIGS. 5A and 5B, and the portion of the process 600 centered under the heading “MCD,” illustratively represents one or more applications executed by the processor 200 of an employee's mobile communication device 16, i.e., one of the mobile communication devices 161-16J associated with an employee of the business enterprise 11, and the portion centered under the heading “Main Server” illustratively represents one or more applications executed by the processor 50 of the main server 12. In one embodiment, the left portion of the process 600 is or includes the ATAM application module 214 stored in the memory 204 (and/or data storage 206) of the employee's mobile communication device 16 in the form of instructions executable by the processor 200 of the employee's mobile communication device 16. The process steps of this portion of the process 600 will be described below for purposes of this disclosure as being executed by the processor 200 of the employee's mobile communication device 16. The right portion of the process 600 is illustratively stored in the MCD processing module 346 in the form of instructions executable by the processor 50 of the main server 12. The process steps of this portion of the process 600 will be described below for purposes of this disclosure as being executed by the processor 50 of the main server 12. In some alternate embodiments, e.g., that may or may not include a main server 12, this portion of the process 600 may alternatively be stored in the memory 34 (and/or data storage 36) of one or more of the local servers 22 in the form of instructions executable by the processor 30 of the one or more local servers 22 and/or stored in a memory and executable by a processor of another system external to or supplemental to the system 10 illustrated FIG. 1. It will further be understood that portions of the process 600 illustrated as being executed by one processor/device or one processor/server or one processor/system may alternatively be executed by a different processor/device or processor/server or processor/system in the system 10, and/or by two or more such processors in any one or combination of such devices, servers and/or systems, some examples of which are described above.

The process 600 begins at step 602 where the processor 50 of the main server 12 is operable to control the communication circuitry 58 to wirelessly transmit to the employee's mobile communication device 16 a mobile application disable message. The employee's mobile communication device 16 receives the wirelessly transmitted signal at step 604, and at step 606 the processor 200 is operable to process the mobile application disable message to determine one or more mobile applications currently running or otherwise accessible to the employee on the employee's mobile communication device 16.

In some embodiments, employees may have installed on their mobile communication devices one or more mobile applications provided by the employer, owned by the employer or controlled by the employer, installed on behalf and/or at the behest of the employer, and/or which may otherwise provide the employee with access to confidential or other employer, employer-owned or employer-controlled information. In such embodiments, the employer may desire for the employee to access and/or to have access to such one or more mobile applications only while the employee is working for the employer, e.g., scheduled to work and clocked in, and to otherwise not access and/or have access to such one or more mobile applications. In such embodiments, the mobile application disable message illustratively identifies such one or more mobile applications and carries instructions to disable them. Following step 606, the processor 200 of the mobile communication device 16 is thus operable to disable such one or more mobile applications. Thereafter, the process 600 terminates and returns to the process 500 or the process 570.

### Employee Off-Schedule Process

### Embodiment 2

Referring now to FIG. 6B, a simplified flow diagram is shown of another embodiment of a process 650 for executing the employee off-schedule process executed at step 507 of the process 500 of FIG. 5A and the process 570 of FIG. 5C. The framework of the process 650 illustrated in FIG. 6B is identical to that illustrated in FIGS. 5A, 5B and 6A and the portion of the process 650 centered under the heading “MCD,” illustratively represents one or more applications executed by the processor 200 of an employee's mobile communication device 16, i.e., one of the mobile communication devices 161-16J associated with an employee of the business enterprise 11, and the portion centered under the heading “Main Server” illustratively represents one or more applications executed by the processor 50 of the main server 12. In one embodiment, the left portion of the process 650 is or includes the ATAM application module 214 stored in the memory 204 (and/or data storage 206) of the employee's mobile communication device 16 in the form of instructions executable by the processor 200 of the employee's mobile communication device 16. The process steps of this portion of the process 650 will be described below for purposes of this disclosure as being executed by the processor 200 of the employee's mobile communication device 16. The right portion of the process 650 is illustratively stored in the MCD processing module 346 in the form of instructions executable by the processor 50 of the main server 12. The process steps of this portion of the process 650 will be described below for purposes of this disclosure as being executed by the processor 50 of the main server 12. In some alternate embodiments, e.g., that may or may not include a main server 12, this portion of the process 650 may alternatively be stored in the memory 34 (and/or data storage 36) of one or more of the local servers 22 in the form of instructions executable by the processor 30 of the one or more local servers 22 and/or stored in a memory and executable by a processor of another system external to or supplemental to the system 10 illustrated FIG. 1. It will further be understood that portions of the process 650 illustrated as being executed by one processor/device or one processor/server or one processor/system may alternatively be executed by a different processor/device or processor/server or processor/system in the system 10, and/or by two or more such processors in any one or combination of such devices, servers and/or systems, some examples of which are described above.

The process 650 begins at step 652 where the processor 200 of the employee's mobile communication device 16 is operable to transmit one or more wireless signals to the main server 12 carrying one or more requests for information stored in the server database 302 or other database coupled thereto or one or more other databases accessible to the processor 50 of the server 12. Thereafter at step 654 the main server 12 receives the wirelessly transmitted signal(s) and at step 656 the processor 50 is operable to determine whether the requested information is information that requires the employee to be working, i.e., scheduled for work and clocked in, in order to qualify for reception thereof. In some embodiments, the processor 50 is operable to execute step 656 by determining whether the requested information is consistent with the employee's normal use and/or assigned work location, whether the requested information is proprietary and/or confidential to the employer, whether the requested information, if provided to the employee while not scheduled for work, not clocked in and/or presently on a work break, may subject the employer to legal or other liability, and/or other considerations. In any case, if at step 656 the processor 50 determines to deny access to the requested information, the process 650 advances to step 658 where the processor 50 wirelessly transmits one or more signals to the employee's mobile communication device carrying a message or notification of denial of access to the requested information. If, at step 656, the processor 50 determines to grant access to the requested information, the process 650 advances to step 660 where the processor 50 wirelessly transmits one or more signals to the employee's mobile communication device carrying the requested information and/or carrying a message or notification of the grant of access to the requested information along with information for accessing such requested information.

Following either of steps 658 and 660, the process 650 advances to step 662 where the employee's mobile communication device receives the transmitted signals and at step 664 the processor 200 controls the display 218 to display the received message or notification. The process 650 terminates following step 664 and is returned to the process 500 or the process 570.

### Mobile Communication Device Process

Referring now to FIG. 8, a simplified flow diagram is shown of a process 800 for executing the mobile communication device process of step 562 of the process 540 illustrated in FIG. 5B. The framework of the process 800 illustrated in FIG. 8 is identical to that illustrated in FIGS. 5A, 5B, 6A, 6B and 7B, and the portion of the process 800 centered under the heading “MCD,” illustratively represents one or more applications executed by the processor 200 of an employee's mobile communication device 16, i.e., one of the mobile communication devices 161-16J associated with an employee of the business enterprise 11, and the portion centered under the heading “Main Server” illustratively represents one or more applications executed by the processor 50 of the main server 12. In one embodiment, the left portion of the process 800 is or includes the ATAM application module 214 stored in the memory 204 (and/or data storage 206) of the employee's mobile communication device 16 in the form of instructions executable by the processor 200 of the employee's mobile communication device 16. The process steps of this portion of the process 800 will be described below for purposes of this disclosure as being executed by the processor 200 of the employee's mobile communication device 16. The right portion of the process 700 is illustratively stored in the MCD processing module 346 in the form of instructions executable by the processor 50 of the main server 12. The process steps of this portion of the process 800 will be described below for purposes of this disclosure as being executed by the processor 50 of the main server 12. In some alternate embodiments, e.g., that may or may not include a main server 12, this portion of the process 800 may alternatively be stored in the memory 34 (and/or data storage 36) of one or more of the local servers 22 in the form of instructions executable by the processor 30 of the one or more local servers 22 and/or stored in a memory and executable by a processor of another system external to or supplemental to the system 10 illustrated FIG. 1. It will further be understood that portions of the process 800 illustrated as being executed by one processor/device or one processor/server or one processor/system may alternatively be executed by a different processor/device or processor/server or processor/system in the system 10, and/or by two or more such processors in any one or combination of such devices, servers and/or systems, some examples of which are described above.

The process 800 begins at step 802 where the processor 50 of the main server 12 is illustratively operable to determine a list of software applications approved for use at the identified one of the facilities, a list of software applications not approved for use at the identified one of the facilities, a list of software applications approved for use outside of the identified one of the facilities and a list of software applications not approved for use outside of the identified facility. Thereafter at step 804, the main server 12 is operable to wirelessly transmit one or more such lists to the identified mobile communication device 16, and the identified mobile communication device 16 thereafter receives the one or more lists at step 806. Thereafter at step 808, the processor 200 of the identified mobile communication device 16 is illustratively operable to enable and/or disable software applications stored thereon in accordance with the one or more lists wirelessly received from the main server 12. Thereafter, the process 800 terminates and returns to step 562 of the process 540.

### Mobile Device Process

Referring now to FIG. 9A, a simplified flow diagram is shown of a process 900 for executing the mobile device process of step 564 of the process 540 illustrated in FIG. 5B. The framework of the process 900 illustrated in FIG. 9A is similar to that illustrated in FIGS. 5A, 5B, 6A, 6B, 7B and 8, and the portion of the process 900 centered under the heading “MSD,” illustratively represents one or more applications executed by a processor of a mobile security device, i.e., an electronic identification device 410 as illustrated in FIG. 4A, or otherwise carried out by such a device. The right portion of the process 900 is illustratively stored in the MD processing module 348 in the form of instructions executable by the processor 50 of the main server 12. The process steps of this portion of the process 900 will be described below for purposes of this disclosure as being executed by the processor 50 of the main server 12.

The process 900 begins at step 902 where the processor 50 of the main server 12 is illustratively operable to process the device identification associated with the electronic identification device 410 and detected by the EDR 28 upon entrance/exit of the identified employee into/from the identified facility 25 to determine the identity of the mobile device 408 to which it is attached, integrated, embedded, etc. Thereafter at step 904, the processor 50 is illustratively operable to update the security device database 312 to identify the location and status, e.g., incoming or outgoing, of the mobile device 408. In some embodiments, the process 900 may further include a process step 906 (not illustrated in FIG. 9A) in which the processor 50 is operable to determine a list of software installed in the device 408, in embodiments in which the device 408 has software installed therein, e.g., by searching for the device 408 in the hardware and software databases 308 and 306 respectively, and to determine whether any such software should be disable or enabled.

Following step 906, in embodiments which include step 906, and otherwise following step 904, the process 900 advances to step 910. In some embodiments, the process 900 may further include a step 918 to which the process 900 also advances from step 904, and in such embodiments the processor 50 is operable to execute a security process for selectively enabling and disabling operation of one or more mobile devices exiting the employer facility. Embodiments of such a security process are illustrated in FIGS. 9B and 10 and will be described in detail hereinafter.

At step 910, the main server wirelessly transmits the information from step 904 (and/or step 906 in embodiments which include step 906) to the device 410, e.g., via the EDR 28, which is received by the EDR at step 912. Thereafter at step 914, the device 410 illustratively stores such information and relays such information to the device 408 at step 916 on subsequent power up. Upon power up, the device 408 receives the list(s) of approved and disapproved software from the device 410, and the device 408 enables and/or disables software programs stored thereon accordingly. The process 900 illustratively terminates after step 908 and returns to step 564 of the process 540, and the process 540 illustratively terminates after execution of either of steps 562 and 564.

### Security Process

Referring now to FIG. 9B, a simplified flow diagram is shown of a process 920 for executing the security process of step 912 of the process 900 illustrated in FIG. 9A. The framework of the process 920 illustrated in FIG. 9B is similar to that illustrated in FIGS. 5A, 5B, 6A, 6B, 7B, 8 and 9A, and the portion of the process 920 centered under the heading MSD illustratively represents one or more applications executed by a mobile security device 408 as illustrated in FIG. 4A, or otherwise carried out by such a device. The right portion of the process 920 is illustratively stored in the MD processing module 348 in the form of instructions executable by the processor 50 of the main server 12. The process steps of this portion of the process 920 will be described below for purposes of this disclosure as being executed by the processor 50 of the main server 12.

The process 920 begins at step 922 where the processor 50 is operable to determine whether the device 408 is outside of the employer facility, and the process 920 loops back to the beginning step 922 until this occurs. Thereafter at step 924, the processor 50 is operable to transmit a device security identifier, SECID, to the mobile security device 410 (and/or to the employee's mobile communication device 16). Thereafter at step 926 the MSD 410 (and/or the employee's mobile communication device 16) is operable to store the device security identifier, SECID, in memory, and thereafter the process 920 terminates.

Referring now to FIG. 10, a process 1000 is shown for ensuring use of the device security identifier, SECID, during subsequent use of the mobile asset device 408 outside of the employer facility in a secure manner. In the process 1000 illustrated in FIG. 10, the portion of the process 1000 centered under the heading Device 410 illustratively represents one or more applications executed by a processor of the mobile asset device 410 as illustrated in FIG. 4A, or otherwise carried out by such a device. The right portion of the process 1000 is illustratively stored in the MSD 408 and/or in the memory 204 of the mobile communication device 16 in the form of instructions executable by the processor 200 of the device 16. The process steps of this portion of the process 1000 will be described below for purposes of this disclosure as being executed by the MSD 408 and/or the mobile communication device 16.

The process 1000 begins at step 1002 where the mobile asset device 410 is powered up outside of the employer facility. Thereafter at step 1004, the communication circuitry of the device 410 transmits a device identifier stored in the memory of the device 410 prior to leaving the employer's facility. At step 1006, the mobile security device 408 and/or mobile communication device 16 receives the transmitted signal, and thereafter at step 1008 the MSD 408 and/or mobile communication device 16 processes the received signal to determine the device identifier. Thereafter at step 1010, the MSD 408 and/or mobile communication device 16 is operable to retrieve the security identifier, SECID, passed to the MSD 408 and/or to the mobile communication device 16 when leaving the employer facility. Thereafter at step 1012, the MSD 408 and/or the processor 200 of the mobile communication device 16 is operable to compare the device identifier and SECID. If they do not match, the process 1000 terminates. If they do match, the MSD 408 and/or the mobile communication device 16 wirelessly transmits a signal to the device 410 carrying, e.g., an acknowledgement signal or message.

Upon receipt of the transmitted signal, the device 410 determines whether the acknowledgement message has been received within a predetermined time period. If so, the process 1000 advances to step 1018 where the device 410 completes power up and allows for use thereof. If, at step 1016, the device 410 determines that an acknowledgement message has not been received within a predefined time period since transmitting the device identifier, the process 1000 advances to step 1020 where the device 410 is operable to display a GUI with a GUI field and instructions to enter an authentication code into the GUI field. Illustratively, the authentication code may be the security code, SECID, and may be displayed when prompted on the display 218 of the employee's mobile communication device 16. Thereafter at step 1022, the device 410 waits until a code is entered, and then at step 1024 the device 410 compares the entered code to the device identifier stored in the device 410. If a match is found at step 1026, the process 1000 advances to step 1018 where the device 410 completes power up. If not, the process 1000 advances to step 1028 where the device 410 powers down and is unusable.

In some embodiments, as illustrated by dashed-line representation in FIG. 10, the mobile asset device 410 and the MDS 408 and/or mobile communication device 16 are operable to periodically exchange communication signals such that the mobile asset device 410 will remain powered up and usable only as long as such communication signal exchange continues, and otherwise the mobile asset device 410 powers down and is unusable.

While the disclosure has been illustrated and described in detail in the drawings and foregoing description, such an illustration and description is to be considered as exemplary and not restrictive in character, it being understood that only illustrative embodiments have been shown and described and that all changes and modifications consistent with the disclosure and recited claims are desired to be protected. Moreover, it will be understood that while several process steps in various sequences have been illustrated and described herein with respect to the processes 500, 540, 570, 600, 650, 700, 750, 800, 900, 920 and 1000, any one or more such processes 500, 540, 570, 600, 650, 700, 750, 800, 900, 920 and 1000 may alternatively include more, fewer and/or different steps, and that any such steps may be executed in different sequences from those illustrated and described, without departing from the scope of the concepts and techniques described herein.

In some of the embodiments described herein, the EDRs 28 have been described as being implemented as wireless signal broadcasting devices, e.g., conventional radio frequency broadcasting beacons, configured to broadcast wireless signals each containing UID. In some alternate embodiments, one or more of the EDRs may be implemented as wireless signal transceivers configured to can broadcast and receive wireless signals and/or as wireless signal receivers configured to receive broadcast wireless signals, e.g., broadcast by a mobile communication device or other device and, in some cases, to communicate directly (wired and/or wirelessly) with the main server 12, one or more of the local hub servers 22 and/or one or more of the POS systems 24. In some such embodiments, one or more of the wireless signal transceivers and/or receivers may include one or more conventional processors and one or more memory devices having instructions stored therein executable by the one or more processors to execute one or more of steps for determining an identity of an individual carrying a mobile communication device within and/or near a facility 25.

In other alternate embodiments, one or more EDRs 28 may be implemented in the form of a combination of conventional Global Positioning System (GPS) satellites and a GPS receiver on-board a mobile communication device.

In other alternate embodiments, one or more EDRs 28 may be implemented in the form of one or more in-store WiFi Access Points which establish one or more in-store or store-wide hotspot having a unique internet access ID (HotSpotID) accessible by a mobile communication device. In such embodiments, the server 12 may determine a location of a mobile communication device in accordance with the unique internet access ID used by the mobile communication device to communicate with the mobile communication device.

In other alternate embodiments, one or more EDRs 28 may be implemented in the form of a combination of the earth's Geomagnetic Field and a magnetometer on-board a mobile communication device. In such embodiments, the server 12 may determine the location of a mobile communication device in accordance with the unique magnetic field signature captured by the magnetometer and wirelessly transmitted to the server 12 by the mobile communication device. In such embodiments, the server database may have one or more maps, tables, lists or the like mapping magnetic signature profiles within one or more of the stores to locations or positions within one or more of the stores, and the server 12 may be operable in such embodiments to determine the in-facility location or position of a mobile communication device by comparing the unique magnetic field signature wirelessly transmitted by the mobile communication device to the stored magnetic signature profiles.

In other alternate embodiments, one or more of the EDRs 28 may be implemented in the form of a combination of a camera on-board a mobile communication device and a product label affixed to product or product location within a store. In such embodiments, the camera may be operated to capture an image of the product label and wirelessly transmit the image to the server. The server may then compare the image to stored product data to determine the in-store location thereof.

In other alternate embodiments, one or more of the EDRs 28 may be implemented in the form of a combination of a mobile communication device with a keypad and a customer/employee application operating on the mobile communication device. In such embodiments, the customer/employee application may display one or more manually selectable GUI elements for manually entering the location of the mobile communication device, and the mobile communication device may then wirelessly transmit the location information to the server.

In other alternate embodiments, one or more of the EDRs 28 may be implemented in the form of a wireless signal transmission device, e.g., RFID Tag, NFC device, etc., attached to customer-selected product. In such embodiments, the wireless signal transmission device may be configured to wirelessly transmit product information (e.g., brand, size, etc.) and/or location (e.g., department, aisle, shelf position, etc.) to a mobile communication device which then wirelessly transmits the information to the server.

In other alternate embodiments, one or more of the EDRs 28 may be implemented in the form of a combination of one or more in-store cameras and a server-based facial and/or product recognition application. In some such embodiments, the server may process camera images and/or video and compare facial images with stored customer images to identify customers. In other embodiments, the server may process the camera images and/or video and compare product images, e.g., in customer's possession (basket, hand-carried, etc.) with stored product images, and then predict the customer's identity based on information contained in customer shopping histories.

In other alternate embodiments, one or more EDRs may be implemented in the form of a combination of one or more electromagnetic radiation (EMR) generators positioned within a facility 25 and a mobile communication device with a camera and/or microphone. In such embodiments, the EMR may be generated in one or more spectral ranges, and be made to vary locally from store-to-store and throughout each store in one or more detectable EMR properties or characteristics, and/or EMR having different properties or characteristics may be generated in each store and in different areas of each store, such that in any case different stores, and different areas within each facility, will be subject to different generated EMR properties or characteristics. The different EMR properties and/or characteristics generated in each store and in each area of each store may be stored in an EMR database, and local EMR properties/characteristics may be detected by a mobile communication device and wirelessly transmitted to the server which may then compare such received information to the EMR database to determine the location of the mobile communication device. Examples of such EMR generators and corresponding EMR detectors include, but are not limited to, one or more visible Light Generators and a camera on-board a mobile communication device, one or more audible frequency Generators and a microphone on-board a mobile communication device, one or more radio frequency generators and a radio frequency generator on board a mobile communication device, and the like.

In other alternate embodiments, one or more EDRs may be implemented in the form of one or more mobile communication devices of one or more in-store customers or in-store Employees. In such embodiments, in-store mobile communication devices may be configured to periodically broadcast signals detected by a customer's mobile communication device and/or transmitted directly to the server. Such broadcast signals be or include “location information” signals based on one or more “hard events” such as a recently received unique identification signal transmitted by an in-store wireless signal broadcasting device, a recently scanned or imaged product code, detected product device data, recently received GPS data, recently used HotSpotID data, recently detected EMR data, and/or the like. Alternatively or additionally, the one or more broadcast signals may be or include location information signals based on one or more “soft events” such as locally detected sounds (generated or not), locally detected light (generated or not), locally detected RF signals, and/or the like.

In any of the foregoing embodiments, information may be transmitted, receive and/or processed by any one or combination of any system or device disclosed herein.

What is claimed is:

1. A method of tracking employee time and attendance, the method comprising:
associating, with a processor in a first database, each of a plurality of device codes stored in the first database with a corresponding identity of one of a plurality of enterprise facilities,
associating, with a processor in the first or a second database, each of a plurality of employee codes with a different one of a plurality of employees of the business enterprise, and
in response to wirelessly received information including a device code and an employee code, determining with the processor the one of the plurality of device codes in the first database that matches the wirelessly received device code, identifying with the processor the one of one or more of the plurality of enterprise facilities associated in the first database with the matching device code, determining with the processor the one of the plurality of employee codes in the first or second database that matches the wirelessly received employee code, and logging in an employee attendance record in the first or the second database identified with the matching employee code the identified one of the plurality of facilities, a calendar date and time of day at which the wirelessly received information was wirelessly received.
